(19) United States
(12) Patent Application Publication
(10) Pub. No.: US 2011/0255526 A1
(43) Pub. Date: Oct. 20, 2011

(54) CELLULAR MOBILE COMMUNICATION SYSTEM, BASE STATION CONTROL DEVICE, AND INTERSTATION-COOPERATED COMMUNICATION CONTROL METHOD

(76) Inventors: Shoji Kaneko, Fujimino-shi (JP); Takashi Inoue, Fujimino-shi (JP); Kei Sakaguchi, Tokyo (JP); Naoki Kusashima, Tokyo (JP); Ian Dexter Garcia, Tokyo (JP)

(21) Appl. No.: 13/141,836

(22) PCT Filed: Dec. 24, 2008
(86) PCT No.: PCT/JP2009/007206

§ 371 Date: Jun. 23, 2011

(30) Foreign Application Priority Data
Dec. 25, 2008 (JP) 2008-330562

(51) Int. Cl. H04B 15/00; H04W 52/00; H04W 4/00

(52) U.S. Cl. 370/338; 455/507; 455/502

(57) ABSTRACT

A cellular mobile communication system, in which a plurality of base stations communicate with mobile stations, provides a retrieval unit, in which each base station retrieves the information regarding the radio communication status of each base station communicating with the predetermined mobile station, a decision unit, which makes a decision as to whether or not to permit interstation-cooperated communication with each base station based on the information, and a determination unit which determines the communication method adopted in the mobile station based on the decision result.

### TECHNICAL FIELD

This invention relates to cellular mobile communication systems, base station control devices, and interstation-cooperated communication control methods.

This invention claims priority on Japanese Patent Application No. 2008-330562 filed on Dec. 25, 2008, the entire content of which is incorporated herein by reference.

### BACKGROUND ART

Recently, a third generation mobile communication system called IMT-2000 (International Mobile Telecommunications 2000) has become commonly used as a cellular phone service in Japan. IMT-2000 includes W-CDMA (Wideband Code Division Multiple Access) and CDMA2000 (Code Division Multiple Access 2000). As the high-speed system of IMT-2000 and the next generation system of IMT-2000, standardization has been developed with regard to a fourth generation mobile communication system called IMT-Advanced.

IMT-Advanced aims to achieve a transmission speed of 1 Gbps at a low mobility and a transmission speed of 100 Mbps at a high mobility. To achieve high-speed communication, it is necessary to employ communication methods utilizing a broadband frequency range. The orthogonal frequency division multiple access (OFDMA) method is known as one of such communication methods. In the OFDMA method, a broadband frequency range is divided into orthogonal narrow bands called subcarriers, so that information is conveyed using subcarriers. According to the OFDMA method, it is possible to correct frequency characteristics, which occur in radio equipment, in units of subcarriers, and it is possible to adaptively perform frequency multiplexing transmission or frequency division multiple access in response to time variations of frequency characteristics occurring in transmission lines. For this reason, the OFDMA method has attracted attention as a promising transmission method to achieve broadband communication.

In the multiple input multiple output (MIMO) technology using multiple antennas, signals independently transmitted with multiple transmitter antennas are received with multiple receiver antennas, so that signals are divided spatially. For this reason, the MIMO technology has attracted attention as a technology for improving frequency availability.

The cellular mobile communication system locates a plurality of base stations so as to organize a continuous communication service area using communication areas (cells) of base stations. When the cellular mobile communication system adopts the communication method employing the OFDMA method and/or the MIMO technology, it is necessary to implement a guideline for allocating all frequency ranges to cells due to the limitation of available frequency ranges. In this case, mobile stations located close to a specific base station are able to receive desired signals at a high level from the base station, whilst radio signals from neighbor base stations decrease in level due to attenuation in distance. Thus, it is possible to secure a high communication quality, and it is expected to achieve a high-speed user throughput owing to the effect of broadband communication. However, mobile stations located in the boundaries of cells may undergo decreased levels of desired signals due to attenuation in distance, whilst radio signals from neighbor base stations may serve as interference signals having the same level as communication signals, so that communication quality should be greatly degraded. This causes a problem in that an effect of broadband communication cannot be obtained adequately. This problem becomes significant particularly in downlinks (i.e. lines from base stations to mobile stations) since base stations have greater transmission power than mobile stations.

For instance, Patent Documents 1, 2, 3 disclose countermeasures to the problem. FIG. 33 is an overview diagram of a conventional cellular mobile communication system. The conventional cellular mobile communication system of FIG. 33 encompasses a plurality of base stations 101, mobile stations (or user terminals) 102, and a base station controller 107. The plurality of base stations 101 provide a plurality of cells 103. The mobile stations 102 are wirelessly connected to the base stations 101 so as to perform communication. The base station controller 107 intensively controls the plurality of base stations 101. The base stations 101 are each connected to a core network 105 via a backbone network 104. The backbone network 104 and the core network 105 have their own routers 106. The base station controller 107 is located in the backbone network 104 and connected to the base stations 101 via wires. The base station controller 107 controls the plurality of base stations 101 such that the plurality of base stations 10 cooperate with each other to perform communication using the MIMO technology on the mobile stations 102 located in the boundaries of cells.

### PRIOR ART DOCUMENT

### Patent Document

Patent Document 1: Japanese Patent Application Publication No. 2007-134844
Patent Document 2: Japanese Patent Application Publication No. 2007-043332
Patent Document 3: Pamphlet of International Publication No. 2006/016485

### SUMMARY OF THE INVENTION

### Problem to be Solved by the Invention

The conventional cellular mobile communication system suffers from a problem in that the processing load to the base station controller 107 increases as the number of base stations controlled by the base station controller 107 increases. It is possible to provide a solution in which the base station controller 107 is designed to control the limited number of base stations 101. In this solution, however, the base stations 101, connected to different base station controllers 107, are not able to cooperate with each other in communication. Alternatively, when a part of the base stations 101 is selected as controlled ones so that uncontrolled base stations and relay stations are placed in the cellular mobile communication system, uncontrolled base stations are not able to cooperate with each other in communication. This may cause distinctions of communication services depending on visited cells of mobile stations.

The cellular mobile communication system performing broadband communication, such as IMT-Advanced, is designed to use micro cells whose sectors are smaller than conventional macro cells. This increases the number of base stations, so that the foregoing problem cannot be undervalued.

To achieve stable communicating states while maintaining connected states of user terminals, the cellular mobile communication system adopts the handover technology for switching connection between different base stations. The handover may include the hard handoff and the soft handoff. The hard handoff causes momentary disconnection in communication and does not involve cooperation between base stations. The soft handoff allows for simultaneous communication with a plurality of base stations in a handover mode but does not involve cooperation between base stations in response to the status of radio communication.

This invention is made under consideration of the foregoing circumstances, wherein the object thereof is to provide a cellular mobile communication system, a base station control device, and an interstation-cooperated communication control method, by which it is possible to enlarge the area allowing for interstation-cooperated communication in which a plurality of base stations cooperate to communicate with mobile stations.

### Means for Solving the Problem

[1] To solve the above problem, the cellular mobile communication system according one aspect of this invention is the cellular mobile communication system in which a plurality of base stations communicates with mobile stations, wherein each base station includes a retrieval unit that retrieves information regarding radio communication status of each base station communicating with a predetermined mobile station, a decision unit that makes a decision whether or not to permit interstation-cooperated communication with each base station based on the information, and a determination unit that determines a communication method adopted in the mobile station base on a decision result.
[2] In this aspect, a survey unit is provided to survey a mobile station which is able to perform spatial multiplexing with the mobile station conducting interstation-cooperated communication.
[3] In this aspect, the decision unit makes a decision whether or not a multi-site connection can be established with a candidate of a base station preferred by the mobile station, wherein when the decision unit determines that the multi-site connection cannot be established with the candidate of the base station preferred by the mobile station, the determination unit selects a single-site connection as the communication method adopted in the mobile station.
[4] In this aspect, each base station further includes a notification unit that notifies another candidate of a base station, other than the base station establishing the single-site connection, of a message that the mobile station communicates with the base station via the single-site connection, wherein the base station, selected as the candidate of the base station, suppresses interference occurring in the mobile station establishing the single-site connection.
[5] In this aspect, the base station, selected as the candidate of the base station, establishes a single-site connection with another mobile station in a radio resource slot which allows the mobile station establishing the single-site connection to perform communication, wherein a suppression unit is provided to reduce transmission power to suppress interference occurring in the mobile station establishing the single-site connection.
[6] In this aspect, the base station, selected as the candidate of the base station, performs beam forming to nullify a direction for the mobile station establishing the single-site connection, wherein a communication unit is provided to communicate with another mobile station by way of beam shaping.
[7] In this aspect, the mobile station includes a transmitter unit that transmits cooperated communication control information, which is necessary to conduct interstation-cooperated communication, to the base station assigned to the mobile station alone, wherein each base station further includes a forwarding unit that forwards the cooperated communication control information, received from the mobile station belonging thereto, to the base station conducting interstation-cooperated communication with the mobile station, and an inquiry unit that sends an inquiry to the base station conducting interstation-cooperated communication about an operation of changing the communication method, so that the decision unit makes a decision whether or not to change the communication method based on the response to the inquiry.
[8] In this aspect, the mobile station further includes a transmitter unit that transmits cooperated communication control information, which is necessary to conduct interstation-cooperated communication, to all the base stations involved in interstation-cooperated communication, wherein the determination unit determines a master base station conducting a main control on interstation-cooperated communication among the base stations involved in interstation-cooperated communication with the base station thereof, and wherein each base station, which is currently selected as the master base station, further includes an inquiry unit that sends an inquiry to the other base station involved in interstation-cooperated communication about an operation of changing the communication method, so that the decision unit makes a decision whether or not to change the communication method based on the response to the inquiry.
[9] In this aspect, the mobile station further includes a request unit that requests the base station to start or change interstation-cooperated communication.
[10] In this aspect, each base station further includes a request unit that requests the mobile station and the base station to start or change interstation-cooperated communication.
[11] The base station control device according to another aspect of this invention is the base station control device installed in a base station communicating with a mobile station, which includes a retrieval unit that retrieves information regarding radio communication status of the base station involved in interstation-cooperated communication with the predetermined base station, a decision unit that makes a decision whether or not to permit interstation-cooperated communication with the base station based on the information, and a determination unit that determines the communication method adopted in the mobile station based on the decision result.
[12] In this aspect, a survey unit is provided to survey a mobile station which is able to perform spatial multiplexing with the mobile station involved in interstation-cooperated communication.
[13] In this aspect, the decision unit makes a decision as to whether or not a multi-site connection can be established with a candidate of a base station preferred by the mobile station, wherein when the decision unit determines that the multi-site connection cannot be established with the candidate of the base station preferred by the mobile station, the determination unit selects a single-site connection as the communication method adopted in the mobile station.
[14] In this aspect, the base station further includes a notification unit that notifies another candidate of a base station, other than the base station establishing the single-site connection, of a message that the mobile station communicates with the base station via the single-site connection, so that the base station, selected as the candidate of the base station, suppresses interference occurring in the mobile station establishing the single-site connection.
[15] In this aspect, each base station further includes a forwarding unit that forwards cooperated communication information, received from the mobile station belonging thereto, to the base station conducting interstation-cooperated communication with the mobile station, and an inquiry unit that sends an inquiry to the base station conducting interstation-cooperated communication about an operation of changing the communication method, wherein the decision unit makes a decision whether or not to change the communication method based on the response to the inquiry.
[16] In this aspect, the determination unit determines a master base station conducting a main control on interstation-cooperated communication among all the base stations involved in interstation-cooperated communication with the base station thereof, wherein the base station, which is selected as the master base station, includes an inquiry unit that sends an inquiry to all the base stations involved in interstation-cooperated communication about an operation of changing the communication method, so that the decision unit makes a decision whether or not to change the communication method based on the response to the inquiry.
[17] In this aspect, a request unit is provided to request the mobile station and the base station to start or change interstation-cooperated communication.
[18] The interstation-cooperated control method according to a further aspect of this invention is the interstation-cooperated communication control method on communication conducted by mobile stations with a plurality of base stations, which includes a step of retrieving the information regarding the radio communication status of the base station conducting interstation-cooperated communication with the predetermined mobile station, a step of making a decision whether or not to permit interstation-cooperated communication with the base station based on the information by means of a base station cooperating unit, and a step of determining the communication method adopted in the mobile station based on the decision result.
[19] In this aspect, a further step is provided to survey a mobile station which is able to perform spatial multiplexing with the mobile station conducting interstation-cooperated communication.
[20] In this aspect, a further step is provided to select a single-site connection as the communication method adopted in the mobile station when it is determined that a multi-site connection cannot be established with a candidate of a base station preferred by the mobile station.
[21] In this aspect, a further step is provided to notify another candidate of a base station, other than the base station establishing the single-site connection, of a message that the mobile station communicates with the base station via the single-site connection while suppressing interference occurring in the mobile station establishing the single-site connection.
[22] In this aspect, a further step is provided to establish a single-site connection with another base station in a radio resource slot that allows the mobile station to perform communication via the single-site connection while reducing transmission power to suppress interference occurring in the mobile station establishing the single-site connection.
[23] In this aspect, a further step is provided to perform beam forming to nullify the direction for the mobile station establishing the single-site connection while communicating with another mobile station by way of beam shaping.
[24] In this aspect, it is possible to further provide a step of transmitting, by the mobile station, cooperated communication control information, which is necessary for the mobile station to conduct interstation-cooperated communication, to the base station assigned to the mobile station alone, a step of forwarding the cooperated communication control information, received from the mobile station assigned to the base station, to another base station involved in interstation-cooperated communication with the mobile station, a step of sending an inquiry to all the base stations conducting interstation-cooperated communication about an operation of changing the communication method, and a step of making a decision whether or not to change the communication method based on the response to the inquiry.
[25] In this aspect, it is possible to further include a step of transmitting, by the mobile station, cooperated communication control information, which is necessary for the mobile station to conduct interstation-cooperated communication, to all the base stations involved in interstation-cooperated communication, a step of determining a master base station conducting a main control on interstation-cooperated communication among all the base stations involved in interstation-cooperated communication, a step of sending an inquiry from the base station, which is currently selected as the master base station, to another base station involved in interstation-cooperated communication about an operation of changing the communication method, and a step of making a decision whether or not to change the communication method based on the response to the inquiry.
[26] In this step, a further step is provided to request, by the mobile station, the base station to start or change interstation-cooperated communication.
[27] In this aspect, a further step is provided to request, by the base station, the mobile station and another base station to start or change interstation-cooperated communication.

### Effect of the Invention

This invention demonstrates an effect in which it is possible to enlarge the area allowing for interstation-cooperated communication, in which a plurality of base stations cooperate to communicate with mobile stations, and to perform interstation-cooperated communication in response to the status of radio communication.

### BRIEF DESCRIPTION OF THE DRAWINGS

FIG. 1 An overview diagram of a cellular mobile communication system according to a first embodiment of this invention.

FIG. 2 A conceptual illustration of communication configurations of the cellular mobile communication system according to the first embodiment.

FIG. 3 A block diagram showing the overall constitution of a base station 1 according to the first embodiment.

FIG. 4 A block diagram showing the overall constitution of a user terminal 2 (or a mobile station) according to the first embodiment.

FIG. 5 A sequence diagram showing a procedure of initiating an interstation-cooperated communication according to the first embodiment.

FIG. 6 A sequence diagram showing another procedure of initiating an interstation-cooperated communication according to the first embodiment.

FIG. 7 A flowchart showing a cooperated communication determination/adjustment process according to the first embodiment.

FIG. 8 A sequence diagram of a simultaneous communication adjustment process according to the first embodiment.

FIG. 9 An example of an interstation-cooperated communication illustrating a cooperated communication determination/adjustment process according to the first embodiment.

FIG. 10 A sequence diagram showing a procedure of initiating an interstation-cooperated communication according to a second embodiment of this invention.

FIG. 11 A sequence diagram showing another procedure of initiating an interstation-cooperated communication according to the second embodiment.

FIG. 12 A flowchart of a cooperated communication determination/adjustment process according to the second embodiment.

FIG. 13 An example of an interstation-cooperated communication illustrating the cooperated communication determination/adjustment process according to the second embodiment.

FIG. 14 A flowchart showing a cooperated communication determination/adjustment process according to the second embodiment.

FIG. 15 A sequence diagram of a simultaneous communication adjustment process according to the second embodiment.

FIG. 16 A sequence diagram showing a procedure of initiating an interstation-cooperated communication according to the second embodiment.

FIG. 17 A sequence diagram showing another procedure of initiating an interstation-cooperated communication according to the second embodiment.

FIG. 18 A sequence diagram showing a procedure of continuing an interstation-cooperated communication according to a third embodiment of this invention.

FIG. 19 A sequence diagram showing a procedure of decreasing the number of base stations cooperating in an interstation-cooperated communication according to the third embodiment.

FIG. 20 A sequence diagram showing a procedure of decreasing the number of base stations cooperating in an interstation-cooperated communication according to the third embodiment.

FIG. 21 A sequence diagram showing another procedure of decreasing the number of base stations cooperating in an interstation-cooperated communication according to the third embodiment.

FIG. 22 A sequence diagram showing another procedure of decreasing the number of base stations cooperating in an interstation-cooperated communication according to the third embodiment.

FIG. 23 A sequence diagram showing a procedure of increasing the number of base stations cooperating in an interstation-cooperated communication according to the third embodiment.

FIG. 24 A sequence diagram showing another procedure of increasing the number of base stations cooperating in an interstation-cooperated communication according to the third embodiment.

FIG. 25 A sequence diagram showing a procedure of continuing an interstation-cooperated communication according to a fourth embodiment of this invention.

FIG. 26 A sequence diagram showing a procedure of decreasing the number of base stations cooperating in an interstation-cooperated communication according to the fourth embodiment.

FIG. 27 A sequence diagram showing a procedure of decreasing the number of base stations cooperating in an interstation-cooperated communication according to the fourth embodiment.

FIG. 28 A sequence diagram showing another procedure of decreasing the number of base stations cooperating in an interstation-cooperated communication according to the fourth embodiment.

FIG. 29 A sequence diagram showing another procedure of decreasing the number of base stations cooperating in an interstation-cooperated communication according to the fourth embodiment.

FIG. 30 A sequence diagram showing a procedure of increasing the number of base stations cooperating in an interstation-cooperated communication according to the fourth embodiment.

FIG. 31 A sequence diagram showing another procedure of increasing the number of base stations cooperating in an interstation-cooperated communication according to the fourth embodiment.

FIG. 32 An example of a cooperated situation in an interstation-cooperated communication according to a fifth embodiment of this invention.

FIG. 33 An overview diagram of a conventional cellular mobile communication system.

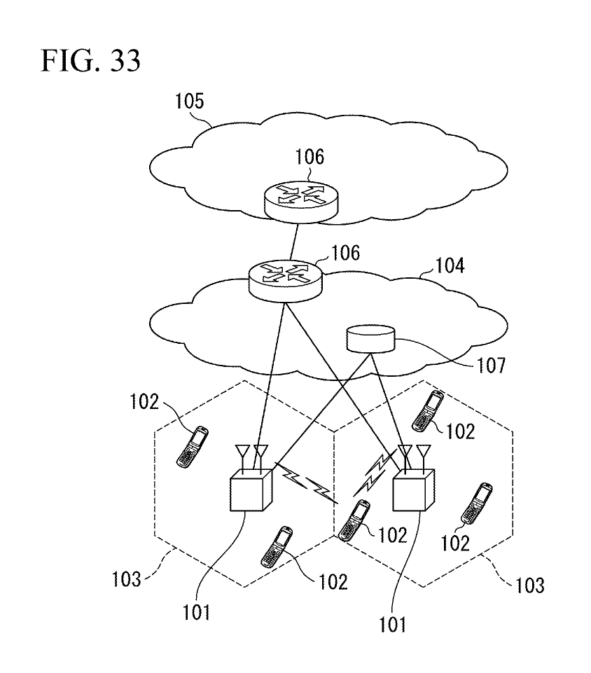

### MODE FOR CARRYING OUT THE INVENTION

Hereinafter, embodiments of this invention will be described with reference to the drawings.

### First Embodiment

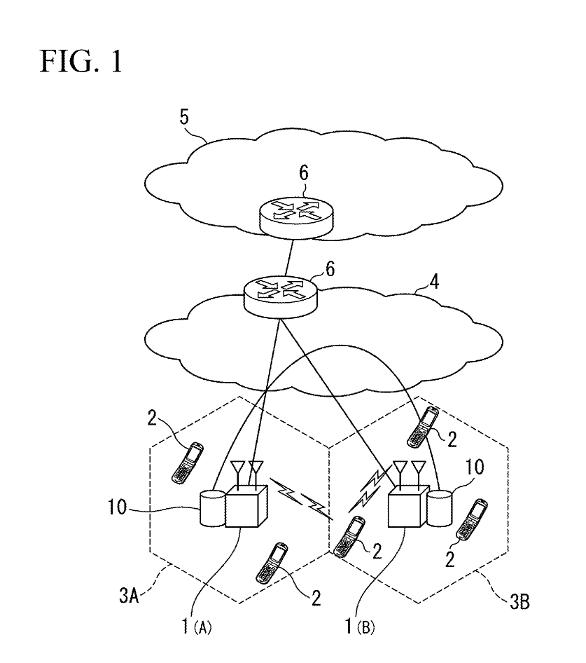

FIG. 1 is an overview diagram of a cellular mobile communication system according to a first embodiment of this invention. The cellular mobile communication system of FIG. 1 encompasses base stations 1 and mobile stations (or user terminals) 2. The base stations 1 provide their cells. The mobile stations 2 are wirelessly connected to the base stations 1 to perform communication. FIG. 1 exemplarily shows two base stations 1 (having base station identifiers A, B), a cell 3A provided by the base station 1(A), and a cell 3B provided by the base station 1(B). The base stations 1 (i.e. the base stations 1(A), 1(B)) include base station cooperating units 10. The base station cooperating units 10 have functions for controlling interstation-cooperated communication.

The base stations 1 are connected to a core network 5 via a backbone network 4. The backbone network 4 and the core network 5 have their own routers 6.

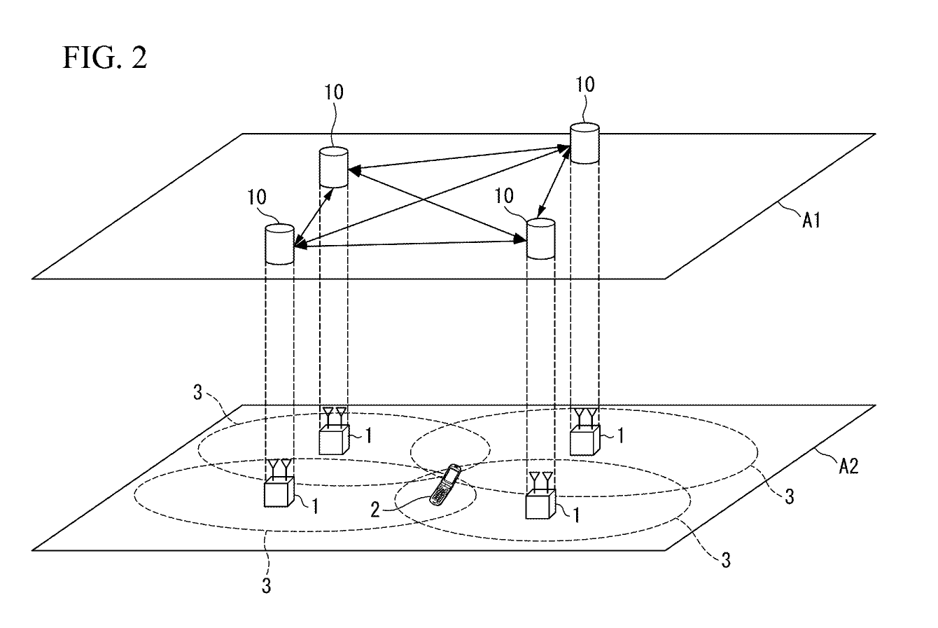

The base station cooperating units 10 of the base stations 1 communicate with each other via the backbone network 4. FIG. 2 is a conceptual illustration showing communication configurations of the cellular mobile communication system according to the first embodiment. In FIG. 2, a real plane A2 illustrates a communication configuration established between the base stations 1 and the user terminal 2. A cooperative plane A1 illustrates a communication configuration for controlling an interstation-cooperated communication, regarding a logical connecting relationship inside the backbone network 4. In the cooperative plane A1, the base station cooperating units 10 are mutually connected in a logically flat full-mesh formation, thus enabling transmission/reception of data between the arbitrary base station cooperating units 10. Communication lines of backbone network 4 are wired lines having adequate communication bands comparable to the amount of data transmitted/received between the base station cooperating units 10. The communication configuration of FIG. 2 is provided independently of the OSI (Open Systems Interconnection) reference model.

The multiple access method adapted between the base stations 1 and the user terminals 2 is not necessarily limited in the cellular mobile communication system of the first embodiment. For instance, it is possible to employ the OFDMA method and the time division multiple access (TDMA) method as the multiple access method.

In the cellular mobile communication system of the first embodiment, the base stations 1 and the user terminals 2 are equipped with a plurality of antennas. Transmission using the MIMO technology (MIMO transmission) is performed between the base stations 1 and the user terminals 2 even when the base station 1 and the user terminal 2 are engaged in one-to-one communication or even when a plurality of base stations 1 cooperate to communicate with the user terminals 2.

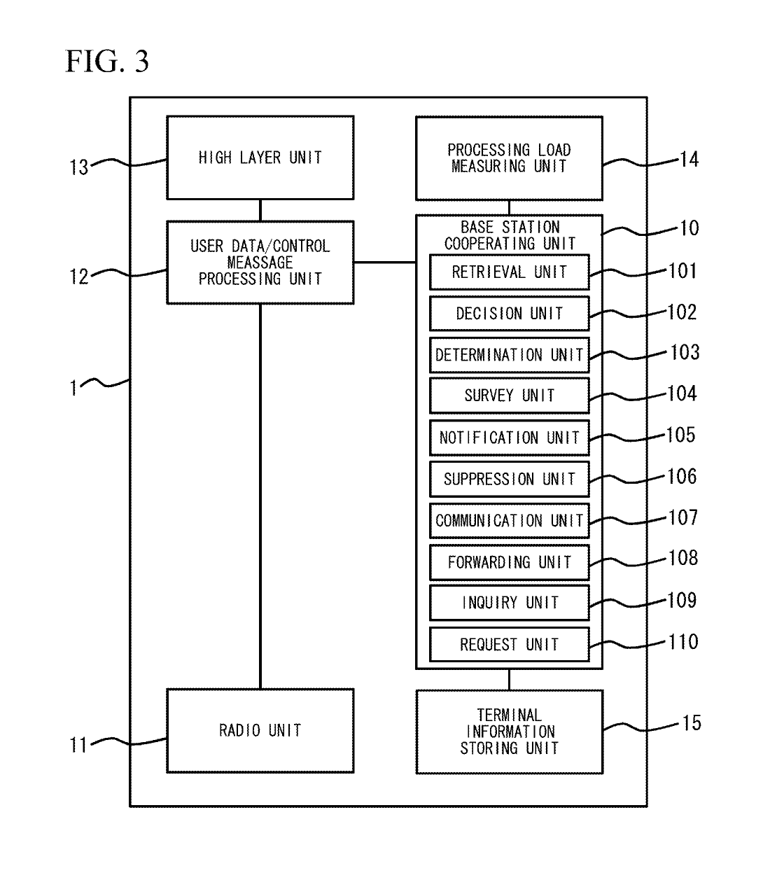

FIG. 3 is a block diagram showing the overall constitution of the base station 1 according to the first embodiment. The base station 1 includes a base station cooperating unit 10, a radio unit 11, a user data/control message processing unit 12, a high layer unit 13, a processing load measuring unit 14, and a terminal information storing unit 15.

In FIG. 3, the radio unit 11 is wirelessly connected to the user terminal 2 so as to transmit/receive user data and control messages. The user data/control message processing unit 12 processes data (i.e. user data, control messages) received/transmitted with the user terminal 2, the base station cooperating unit 10 of the other base station 1, and the core network 5. The high layer unit 13 is connected to the backbone network 4 via wires so as to receive/transmit user data and control messages.

The processing load measuring unit 14 measures the processing load imparted to the base station 1 by itself. The measured result of the processing load is supplied to the base station cooperating unit 10. The terminal information storing unit 15 stores the information regarding the status of radio communication per each user terminal 2. The information stored in the terminal information storing unit 15 represents permitted/unpermitted adoption of interstation-cooperated communication with the user terminals 2, radio resources assigned to the user terminals 2, and the MIMO transmission method (or the MIMO mode), or the like. As the MIMO mode, for example, it is possible to name the transmission diversity such as the maximum ratio composite transmission diversity, space-time coding, and spatial multiplexing such as eigen beam spatial multiplexing as well as their combinations. The cooperating unit 10 writes data into the terminal information storing unit 15 or reads data from the terminal information storing unit 15.

The base station cooperating unit 10 transmits/receives control messages with the user terminal 2 or the base station cooperating unit 10 of the other base station 1 by way of the user data/control message processing unit 12. The base station cooperating unit 10 controls interstation-cooperated communication by way of transactions of control messages.

The base station cooperating unit 10 of the base station 1 includes a retrieval unit 101, a decision unit 102, a determination unit 103, a survey unit 104, a notification unit 105, a suppression unit 106, a communication unit 107, a forwarding unit 108, an inquiry unit 109, and a request unit 110.

The retrieval unit 101 retrieves information regarding the status of radio communication from the base stations 1 each communicated with a specific mobile station, i.e. the user terminal 2.

The decision unit 102 makes a decision as to whether or not an interstation-cooperated communication can be performed using the base station 1 based on the information retrieved by the retrieval unit 101. The decision unit 102 makes a decision as to whether or not a multi-site connection can be made using a desired candidate of base station selected by the user terminal 2. The decision unit 102 makes a decision whether or not to change the communication method based on the inquiry result of the inquiry unit 109.

Based on the decision of the decision unit 102, the determination unit 103 determines the communication method for the user terminal 2. When the decision unit 102 assumes that a multi-site connection cannot be made using a desired candidate of base station selected by the user terminal 2, the determination unit 103 selects a single-site connection as the communication method for the user terminal 2. Additionally, the determination unit 103 selects a master base station, which is involved in a main control on an interstation-cooperated communication, from among the other base stations 1 which perform interstation-cooperated communication with the current base station 1.

The survey unit 104 surveys mobile stations which can be involved in spatial multiplexing with the user terminal 2 performing an interstation-cooperated communication.

The notification unit 105 notifies other candidates of the base stations 1, other than the base station 1 selected for a single-site connection, of the decision that the user terminal 2 is to communicate with the selected base station 1 via a single-site connection.

The suppression unit 106 is installed in each candidate of base station to suppress interference occurring with the user terminal 2 which is selected for a single-site connection and notified by the notification unit 105. Additionally, the suppression unit 106 suppresses transmission power to suppress interference occurring with the user terminal 2, which is selected for a single-site connection and notified by the notification unit 105, while establishing single-site connections with other user terminals 2 in a radio resource slot in which the user terminal 2, which is selected for a single-site connection and notified by the notification unit 105, is able to perform communication.

The communication unit 107 is installed in a candidate of the base station 1 to perform beam forming, nullifying the direction for the user terminal 2 which is selected for a single-site connection and notified by the notification unit 105, while performing communication with the other user terminals 2 by way of the beam shape.

The forwarding unit 108 forwards cooperated communication control information, which is received from the user terminal 2 belonging to the current base station 1, to the base station 1 which is involved in an interstation-cooperated communication with the user terminal 2.

The inquiry unit 109 makes an inquiry whether to change the communication method in each of the base stations 1 which are involved in an interstation-cooperated communication. Additionally, the inquiry unit 109 installed in the base station 1 currently serving as a master base station makes an inquiry whether to change the communication method in each of the base stations 1 which are involved in interstation-cooperated communication.

The request unit 110 requests the user terminal 2 and the base station 1 to initiate or change an interstation-cooperated communication.

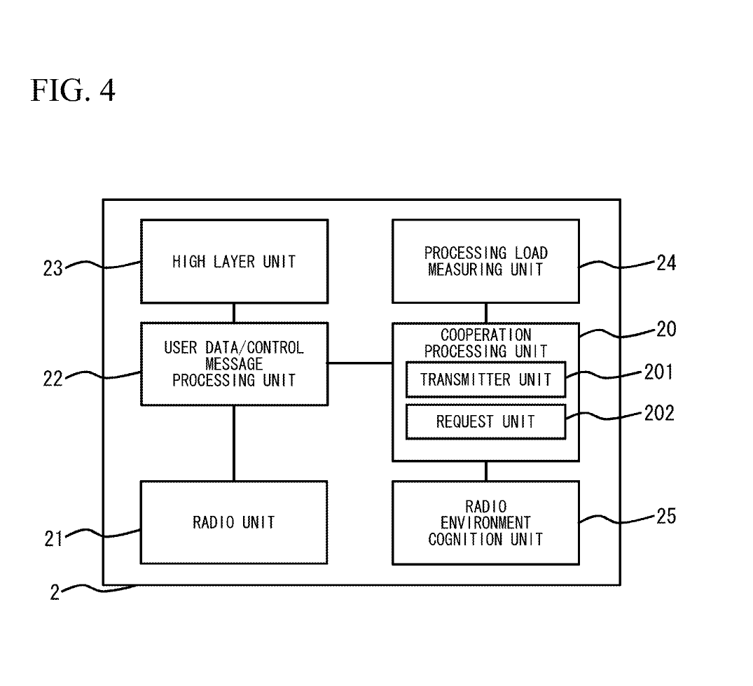

FIG. 4 is a block diagram showing the overall constitution of the user terminal 2 according to the first embodiment. The user terminal 2 includes a cooperation processing unit 20, a radio unit 21, a user data/control message processing unit 22, a high layer unit 23, a processing load measuring unit 24, and a radio environment cognition unit 25.

In FIG. 4, the radio unit 21 is wirelessly connected to the base station 1 so as to transmit/receive user data and control messages. The user data/control message processing unit 22 processes data (i.e. user data, control messages) which are transmitted/received with the base station 1. The high layer unit 23 is configured of an application installed in the current user terminal 2 so as to transmit/receive user data and control messages with the base station 1 by way of the user data/control message processing unit 22.

The processing load measuring unit 24 measures the processing load imparted to the current user terminal 2. The measured result of the processing load is supplied to the cooperation processing unit 20. The radio environment cognition unit 25 periodically measures radio quality information, regarding radio quality, per each base station 1 serving as a transmission source of radio signals, based on radio signals received with an antenna (not shown) of the current user terminal 2. The measurement is performed with respect to all the measurable base stations 1 regardless of the connected/disconnected status with the current user terminal 2. The measured result of the radio quality information is supplied to the cooperation processing unit 20. As the radio quality information, for example, it is possible to name a carrier to interference and noise power ratio (CINR) and a received signal strength indicator (RSSI). In the measurement of CINR, a desired base station is determined by setting thresholds to RSSI values for the base stations 1 and RSSI differences between the base stations 1, so that the base station 1 whose RSSI value and RSSI difference satisfy thresholds is selected as a desired base station. Subsequently, the measurement of CINR is performed on each pair of a desired base station and another base station 1.

The cooperation processing unit 20 transmits/receives control messages with the base stations 1 by way of the user data/control message processing unit 22. The cooperation processing unit 20 performs processing relating to an interstation-cooperated communication.

The cooperation processing unit 20 of the user terminal 2 includes a transmitter unit 201 and a request unit 202.

The transmitter unit 201 transmits cooperated communication control information, which is needed to perform an interstation-cooperated communication, to the base station 1, which the transmitter unit 201 belongs to; alternatively, the transmitter unit 201 transmits cooperated communication control information, which is needed to perform an interstation-cooperated communication, to all the base stations 1 involved in interstation-cooperated communication.

The request unit 202 requests the base station 1 to initiate or change an interstation-cooperated communication.

Next, a series of operations relating to interstation-cooperated communication in the cellular mobile communication system of the first embodiment will be described in details. In the following exemplary embodiments, the number of antennas installed in the base station 1 and the number of antennas installed in the user terminal 2 are each set to two, but it is possible to use three or more antennas.

For the sake of convenience, the following description precludes the numeral “1” from the base station and the numeral “2” from the user terminal. Additionally, the terms “base station” and “base station identifier” are linked together such that a base station A denotes the base station 1 assigned with a base station identifier A, whilst a base station B denotes the base station 1 assigned with a base station identifier B.

The first embodiment refers to a procedure of initiating interstation-cooperated communication established with the maximally two base stations. In this connection, the first embodiment does not locate two base stations but three or more base stations in the cellular mobile communication system.

[Procedure of Initiating an Interstation-Cooperated Communication]

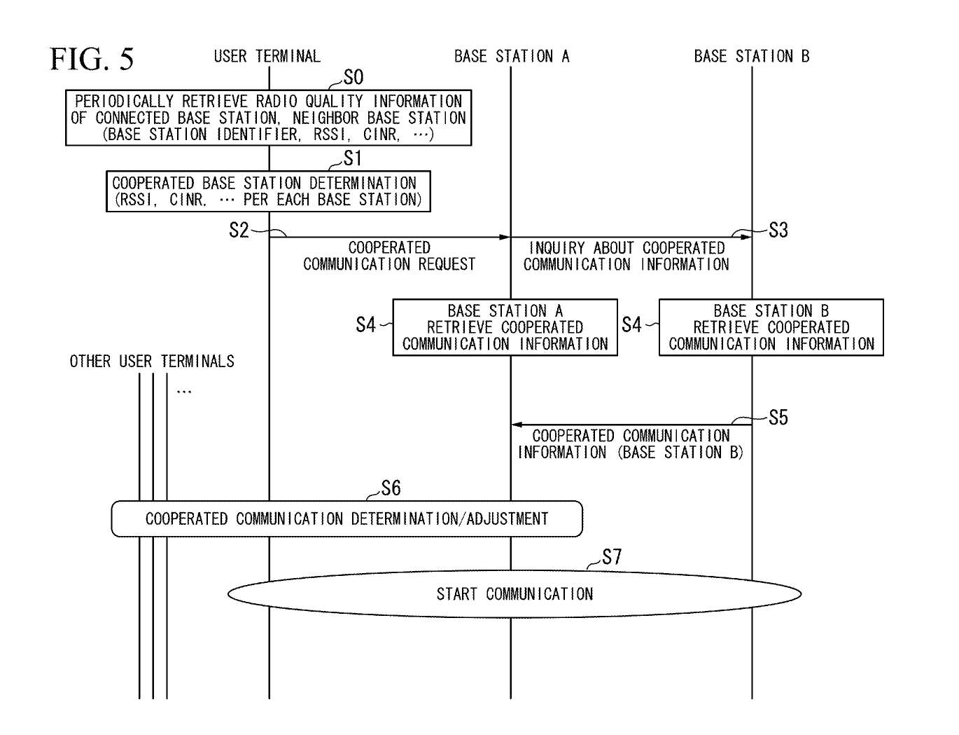

FIG. 5 shows a procedure of initiating an interstation-cooperated communication with the base stations A, B when the user terminal communicating with the base station A alone moves into the boundary between the cell of the base station A and the cell of the base station B. Hereinafter, a procedure of initiating an interstation-cooperated communication will be described with reference to FIG. 5.

In step S0, a user terminal periodically measures radio quality information per each base station.

In step S1, the user terminal makes a decision whether to request an interstation-cooperated communication with the base stations A, B based on the radio quality information per each base station. As the decision criterion, for example, the user terminal may determine to request an interstation-cooperated communication with a connected base station and an unconnected base station when an RSSI value of the connected base station decreases while an RSSI difference with the unconnected base station, which is one of base stations other than the connected base station, falls within a reference value range. Alternatively, an estimate value of a transmission speed, which is obtained when the user terminal is connected to the connected base station alone, and an estimate value of a transmission speed, which is obtained by way of an interstation-cooperated communication between the connected base station and the unconnected base station, are calculated, so that the user terminal may determine to request an interstation-cooperated communication when the comparison result of the calculated values yields a good transmission speed.

In step S2, the user terminal sends a cooperated communication request to the base station A. The cooperated communication request contains a pair of base stations conducting an interstation-cooperated communication, an MIMO mode adopted in the interstation-cooperated communication, radio quality information per each base station (including the base stations subjected to the interstation-cooperated communication, and other base stations not subjected to the interstation-cooperated communication), and information regarding a processing load imparted to the current user terminal. Herein, a pair of base stations conducting an interstation-cooperated communication corresponds to the base stations A, B.

In step S3, the base station A makes inquiry about the cooperated communication information with the base station B. In the inquiry about the cooperated communication information, the base station sends the MIMO mode, the radio quality information per each base station and the information regarding the processing load to the inquiry-destined base station.

In step S4, the base stations A, B acquire their cooperated communication information respectively. The cooperated communication information contains vacant slots available for interstation-cooperated communication, the number of user terminals, which are determined in advance in accordance with interstation-cooperated communication, a pair of base stations conducting interstation-cooperated communication in association with user terminals, and information regarding a processing load imparted to the current base station.

In step S5, the base station B sends back the retrieved cooperated communication information to the base station A.

In step S6, a cooperated communication determination/adjustment process is conducted between the base station A and the user terminal in accordance with the cooperated communication information of the base station A and the cooperated communication information of the base station B, thus determining a communication method applied to the user terminal which is a source of transmitting the cooperated communication request.

In step S7, a communication is started between the user terminal and the base station in accordance with the communication method which is determined in step S6.

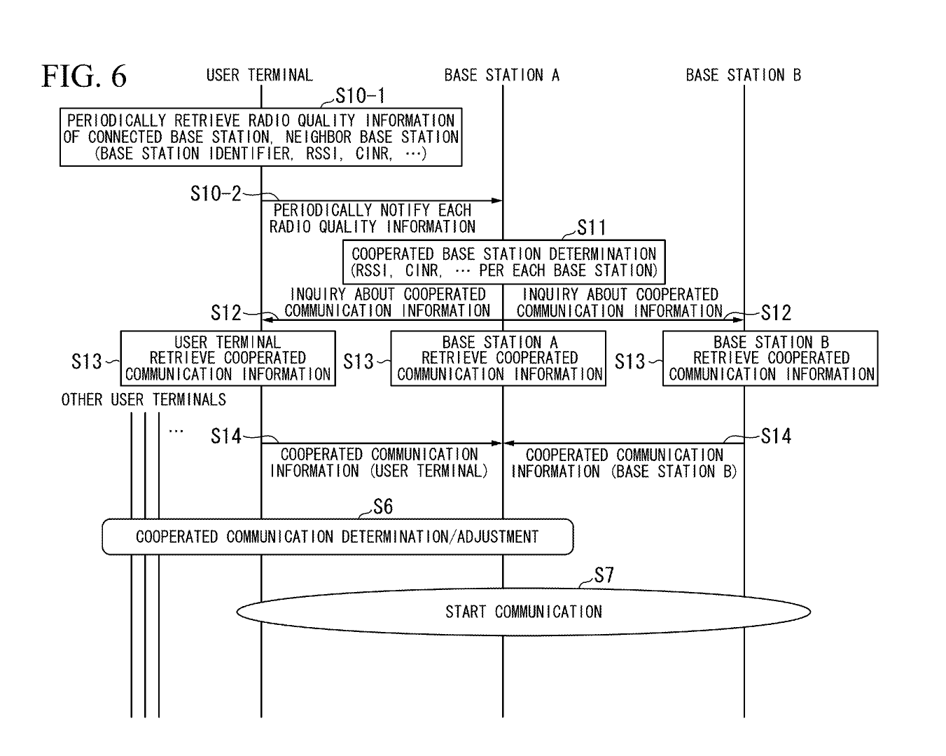

FIG. 6 is a sequence diagram showing another procedure of initiating an interstation-cooperated communication. Similar to FIG. 5, FIG. 6 shows a procedure in which an interstation-cooperated communication between the base stations A, B is started when the user terminal, which is communicating with the base station A alone, moves to the boundary between the cell of the base station A and the cell of the base station B. The initiating procedure of FIG. 6 is equivalent to that of FIG. 5, wherein the initiating procedure of FIG. 5 causes the user terminal to request an interstation-cooperated communication, whilst the initiating procedure of FIG. 6 causes the base station to request an interstation-cooperated communication. Hereinafter, another procedure of initiating an interstation-cooperated communication will be described with reference to FIG. 6.

In step S10-1, the user terminal periodically measures radio quality information per each base station.

In step S10-2, the user terminal periodically sends radio quality information to the base station A.

In step S11, the base station A decides to request that the base stations A, B be selected as candidates for performing interstation-cooperated communication with the user terminal based on radio quality information per each base station. The decision criterion is identical to that of step S1 in FIG. 5.

In step S12, the base station A makes inquiries about cooperated communication information with the user terminal and the base station B, which are related to a request of an interstation-cooperated communication. As an inquiry of cooperated communication information with the base station B, radio quality information per each base station and information of the MIMO mode or the like are sent to the base station B. As an inquiry of cooperated communication information with the user terminal, information regarding a pair of base stations (herein, the base stations A, B) conducting an interstation-cooperated communication, the MIMO mode or the like is sent to the user terminal.

In step S13, the user terminal and the base stations A, B acquire their cooperated communication information respectively. The cooperated communication information of the user terminal contains a processing load imparted to the user terminal and the latest radio quality information per each base station subjected to the interstation-cooperated communication (herein, the base stations A, B). The cooperated communication information of the base stations A, B contains vacant slots available for interstation-cooperated communication, the number of user terminals, which are determined in advance in accordance with interstation-cooperated communication, a pair of base stations conducting interstation-cooperated communication with user terminals, and a processing load imparted to each base station.

In step S14, the user terminal and the base station B send back their retrieved cooperated communication information to the base station A. Steps S6 and S7 are identical to those shown in FIG. 5.

### [Cooperated Communication Determination/Adjustment Process of Interstation-Cooperated Communication (Step S6 in FIGS. 5 and 6)]

Next, a cooperated communication determination/adjustment process of interstation-cooperated communication conducted by maximally two base stations, which corresponds to step S6 shown in FIGS. 5 and 6, will be described.

Based on the cooperated communication information of the base stations A, B, the base station A selects the corresponding cooperation permitted/unpermitted pattern from among four combinations of permitted/unpermitted interstation-cooperated communication (i.e. cooperation permitted/unpermitted patterns (I), (II), (III), (IV)) shown in Table 1. The base station A performs an adjustment process according to the selected cooperation permitted/unpermitted pattern.

TABLE 1

| Cooperation | | |
|---|---|---|
| permitted/unpermitted patterns | Base station A | Base station B |
| (I) | Permitted | Permitted |
| (II) | Permitted | Unpermitted |
| (III) | Unpermitted | Permitted |
| (IV) | Unpermitted | Unpermitted |

Hereinafter, a series of operations relating to cooperation permitted/unpermitted patterns will be described.

(I) Base Station A: Cooperation Permitted Status, Base Station B: Cooperation Permitted Status

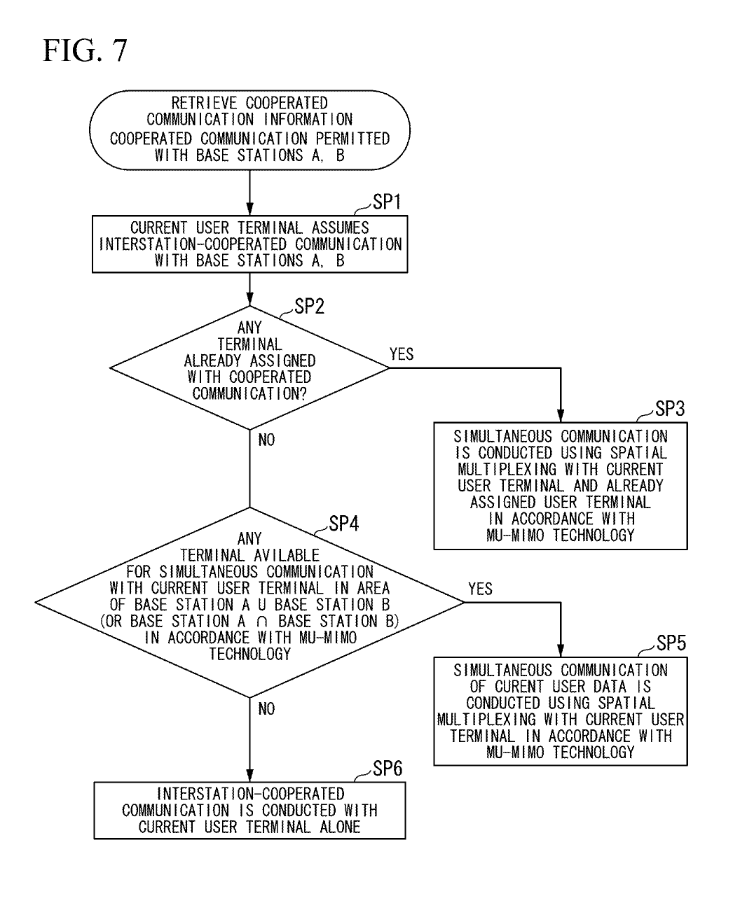

The base station A performs a process shown in FIG. 7 when the vacant slot information and processing loads of the base stations A, B indicate that both the base stations A, B are afford to cooperate together in connection with the user terminal. FIG. 7 is a flowchart showing a cooperated communication determination/adjustment process of interstation-cooperated communication. The cooperated communication determination/adjustment process according to the cooperation permitted/unpermitted pattern (I) of Table 1 will be described with reference to FIG. 7.

In step SP1, the base station A assumes that the base stations A, B are able to conduct interstation-cooperated communication in connection with the user terminal base on the cooperated communication information of the base stations A, B.

In step SP2, the base station A checks whether another user terminal, other than the foregoing user terminal, is subjected to interstation-cooperated communication with the base stations A, B, which are determined in advance.

In step SP3, when another user terminal, other than the foregoing user terminal, is subjected to interstation-cooperated communication with the base stations A, B, which are determined in advance (i.e. YES in step SP2), the base station A determines that simultaneous communication is performed using spatial multiplexing with the foregoing user terminal and another user terminal in accordance with the MU-MIMO (Multi-User MIMO) technology.

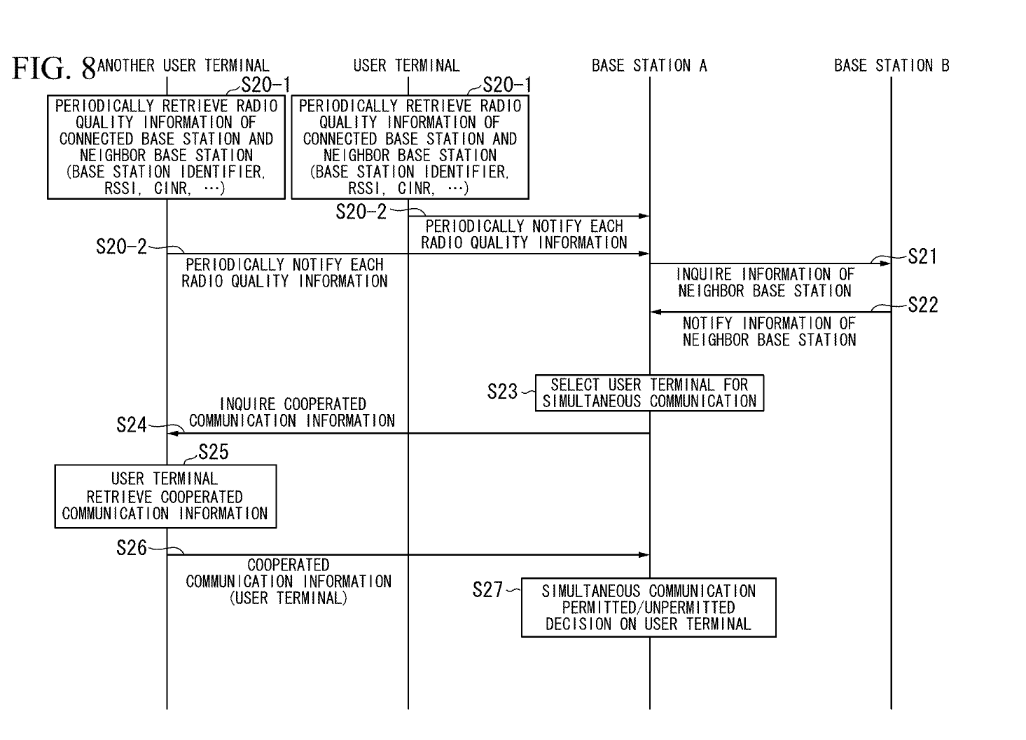

In step SP4, when no user terminal, other than the foregoing user terminal, is subjected to interstation-cooperated communication with the base stations A, B, which are determined in advance (i.e. NO in step SP2), the base station A searches for another user terminal, which is able to perform simultaneous communication with the foregoing user terminal in accordance with the MU-MIMO technology, from among other user terminals located in the area corresponding to the cell of the base station A or the cell of the base station B (or the overlapped sector between the cells of the base stations A, B). FIG. 8 is a sequence diagram showing the simultaneous communication adjustment process.

Next, the simultaneous communication adjustment process will be described with reference to FIG. 8.

In step S20-1, each user terminal periodically measures radio quality information per each base station.

In step S20-2, each user terminal periodically sends radio quality information to the base station A.

In step S21, the base station A inquires the base station B about information of a neighbor base station (neighbor BS information). The neighbor BS information is radio quality information per each base station received from each user terminal and is related to information which the user terminal serving as a transmitting source is able to specify.

In step S22, the base station B sends back neighbor BS information, stored therein, to the base station A.

In step S23, the base station A selects another user terminal, which conducts simultaneous communication with the foregoing user terminal subjected to an interstation-cooperated communication, based on the neighbor BS information thereof and the received neighbor BS information from the base station B. For instance, the base station A selects another user terminal conducting simultaneous communication on the condition that reception power by the base stations A, B does not significantly differ from reception power by the foregoing user terminal, and an interstation-cooperated communication can be conducted with the base stations A, B.

In step S24, the base station A inquires another user terminal, which is selected in step S23, about cooperated communication information.

In step S25, another user terminal receiving an inquiry about cooperated communication information retrieves cooperated communication information.

In step S26, another user terminal sends back the retrieved cooperated communication information to the base station A.

In step S27, the base station A makes a decision as to whether or not simultaneous communication is permitted with the foregoing user terminal based on the cooperated communication information from another user terminal. When the decision result indicates that simultaneous communication is not permitted, the flow returns to step S23, so that the base station A selects a further user terminal; hence, steps following step S24 may be repeated.

When another user terminal, which is selected in step S23, is able to communicate with the base station B alone, the base station B prior to step S24 is requested to make a decision whether or not to permit cooperated communication, following step S24, based on the information of another user terminal.

Reference is made back to FIG. 7.

In step SP5, the base station A determines that simultaneous communication is performed using spatial multiplexing with the foregoing user terminal and another user terminal in accordance with the MU-MIMO technology when the base station A finds out another use terminal which is able to perform simultaneous communication with the foregoing user terminal (i.e. YES in step SP4).

In step SP6, the base station A decides to perform interstation-cooperated communication with the foregoing user terminal alone without using the MU-MIMO technology when the base station A fails to find out another user terminal which is able to perform simultaneous communication with the foregoing user terminal (i.e. NO in step SP4).

(II) Base Station A: Cooperation Permitted Status, Base Station B: Cooperation Unpermitted Status

When the vacant slot information and processing loads of the base stations A, B indicate that the base station A is permitted to cooperate with the user terminal while the base station B is unpermitted to cooperate with the user terminal, the base station A decides to perform one-to-one communication with the user terminal regardless of a decision result as to whether or not another user terminal other than the foregoing user terminal is subjected to interstation-cooperated communication with the base stations A, B, which are determined in advance.

Hereinafter, one-to-one communication conducted between one user terminal and one base station will be referred to as “single-site connection”, whilst one-to-plural communication conducted between one user terminal and plural base stations will be referred to as “multi-site connections”.

The base station A notifies the base station B of its decision to communicate with the foregoing user terminal via a single-site connection. To establish a single-site connection with another user terminal, located close to the base station B, in a radio resource slot, which allows the foregoing user terminal to perform communication, and to suppress interference occurring in the foregoing user terminal which establish a single-site connection with the base station A, the base station B reduces its transmission power in communication. Alternatively, the base station B adopts the beam forming technology to nullify the direction for the foregoing user terminal establishing a single-site connection with the base station A and to communicate with another user terminal enabling a single-site connection to be established with the base station B in the beam shaping.

(III) Base Station A: Cooperation Unpermitted Status, Base Station B: Cooperation Permitted Status

When the vacant slot information and processing loads of the base stations A, B indicate that the base station A is unpermitted to cooperate with the user terminal while the base station B is permitted to cooperate with the user terminal, the base station A performs either the next process (III-1) or (III-2) regardless of a decision result as to whether or not another user terminal other than the foregoing user terminal is subjected to interstation-cooperated communication with the base stations A, B, which are determined in advance.

Process (III-1): The base station A decides to establish a single-site connection with the foregoing user terminal. The base station A notifies the base station B of its decision to communicate with the foregoing user terminal via a single-site connection. To establish a single-site connection with another user terminal, located close to the base station B, in a radio resource slot, which allows the foregoing user terminal to perform communication, and to suppress interference occurring in the foregoing user terminal which establish a single-site connection with the base station A, the base station B reduces its transmission power in communication. Alternatively, the base station B adopts the beam forming technology to nullify the direction for the foregoing user terminal establishing a single-site connection with the base station A and to communicate with another user terminal enabling a single-site connection to be established with the base station B in the beam shaping.

Process (III-2): The base station A decides to establish a single-site connection between the foregoing user terminal and the base station B. This is because the base station A, which the user terminal belongs to, bears a heavy processing load and does not afford to cooperate with the user terminal; in other words, it is expected to improve communication quality by establishing a single-site connection between the foregoing user terminal and the base station B. The base station A requests the base station B to establish a single-site connection with the user terminal. In response to a request of the base station A, the base station B notifies the base station A of its decision to communicate with the foregoing user terminal via a single-site connection. To establish a single-site connection with another user terminal, located close to the base station A, in a radio resource slot, which allows the foregoing user terminal to perform communication, and to suppress interference occurring in the foregoing user terminal establishing a single-site connection with the base station B, the base station A reduces its transmission power in communication. Alternatively, the base station A adopts the beam forming technology to nullify the direction for the foregoing user terminal establishing a single-site connection with the base station B and to communicate with another user terminal enabling a single-site connection to be established with the base station A in the beam shaping.

(IV) Base Station A: Cooperation Unpermitted Status, Base Station B: Cooperation Unpermitted Status

When the vacant slot information and processing loads of the base stations A, B indicate that both the base stations A, B are unpermitted to communicate with the user terminal, the base station A decides to establish a single-site connection with the foregoing user terminal regardless of a decision result as to whether or not another user terminal, other than the foregoing user terminal, is subjected to interstation-cooperated communication with the base stations A, B, which are already determined. The base station A notifies the base station B of its decision to communicate with the foregoing user terminal via a single-site connection. To establish a single-site connection with another user terminal, located close to the base station B, in a radio resource slot, which allows the user terminal to perform communication, and to suppress interference occurring in the foregoing user terminal establishing a single-site connection with the base station A, the base station B reduces its transmission power in communication. Alternatively, the base station B adopts the beam forming technology to nullify the direction for the foregoing user terminal establishing a single-site connection with the base station A and to communicate with another user terminal enabling a single-site connection to be established with the base station B in the beam shaping.

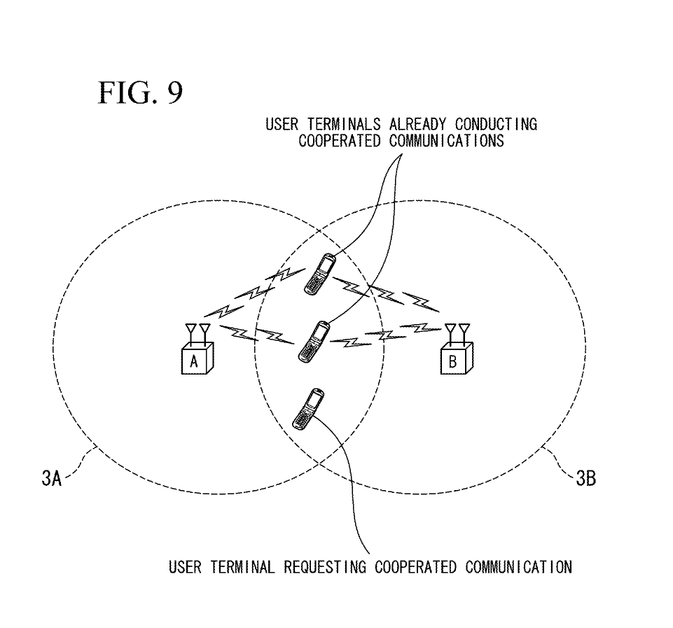

As the situation that both the base stations A, B are unpermitted to cooperate with the user terminal, it is possible to name the situation that both the base stations A, B have a high processing load and the situation that a further interstation-cooperated communication with the foregoing user terminal cannot be added since the base stations A, B have already conducted interstation-cooperated communication with other user terminals. FIG. 9 is a conceptual illustration in which the base stations A, B have already conducted interstation-cooperated communication with other user terminals so that a further interstation-cooperated communication with the foregoing user terminal cannot be added.

When the base stations A, B decide to conduct interstation-cooperated communication with the foregoing user terminal by way of the cooperated communication determination/adjustment process for interstation-cooperated communication, the base stations (i.e. the base stations A, B) cooperate with each other to conduct interstation-cooperated communication and to determine an assigned radio resource (slot) based on the vacant slot information and the MIMO mode. The same slot needs to be assigned to the base stations A, B in order to establish a multi-site connection. When a single-site connection is established between the user terminal and any one of base stations, an assigned radio resource (slot) is determined based on the vacant slot information and the MIMO mode of the base station establishing a single-site connection.

### Second Embodiment

A second embodiment is related to a procedure of initiating interstation-cooperated communication with maximally three base stations. The second embodiment is adapted to the cellular mobile communication system which does not necessarily encompass three base stations but can encompass four or more base stations. The reason why the limited number of base stations conducting interstation-cooperated communication is to prevent control processing for interstation-cooperated communication from being extended in a broad range. The second embodiment limits the number of base stations conducting interstation-cooperated communication to three, but the procedure of the second embodiment can be applied to interstation-cooperated communication conducted with maximally four or more base stations.

[Procedure of Initiating Interstation-Cooperated Communication]

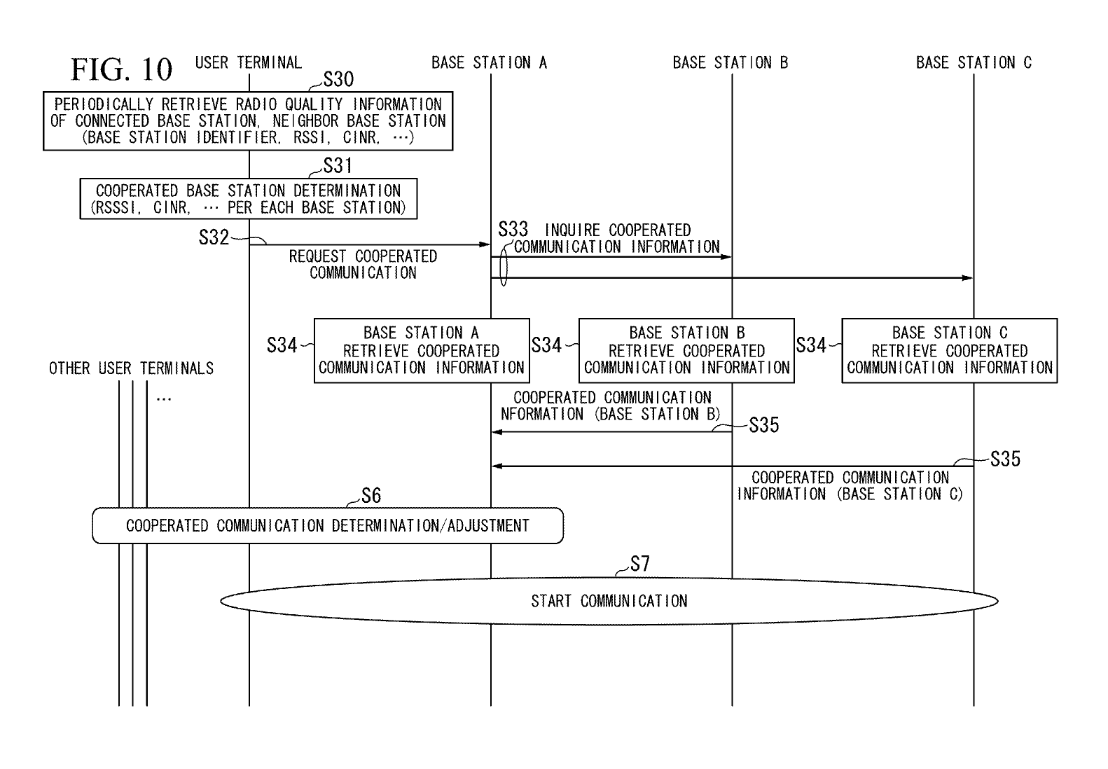

FIG. 10 is a sequence diagram showing a procedure of initiating interstation-cooperated communication. The procedure of FIG. 10 allows the user terminal, which is currently communicating with the base station A alone, to start interstation-cooperated communication with three base stations A, B, C when the user terminal moves into the common boundary among the cells of base stations A, B, C. Hereinafter, the procedure of initiating interstation-cooperated communication will be described with reference to FIG. 10.

In step S30, the user terminal periodically measures radio quality information per each base station.

In step S31, the user terminal makes a decision whether to request interstation-cooperated communication with the base stations A, B, C based on radio quality information per each base station. The decision criterion is identical to the decision criterion of step S1 in FIG. 5.

In step S32, the user terminal sends a cooperation communication request to the base station A. The cooperated communication request contains a combination of base stations conducting interstation-cooperated communication, the MIMO mode used for interstation-cooperated communication, radio quality information per each base station (which may be included in base stations subjected to interstation-cooperated communication and other base stations not subjected to interstation-cooperated communication), and information regarding a processing load of the user terminal. Herein, the combination of base stations conducting interstation-cooperated communication includes the base stations A, B, C.

In step S33, the base station A inquires the base stations B, C about cooperated communication information. As an inquiry of cooperated communication information, received information from the user terminal, such as the MIMO mode, the radio quality information per each base station and the processing load, is sent to the base station making such an inquiry.

In step S34, the base station A, B, C retrieve their cooperated communication information. The cooperated communication information contains vacant time slots available for interstation-cooperated communication, the number of user terminals which are determined in advance in accordance with interstation-cooperated communication, a combination of base stations conducting interstation-cooperated communication with user terminals, and the information regarding a processing load of each base station.

In step S35, the base stations B, C send back their retrieved cooperated communication information to the base station A.

In step S6, the base station A and the user terminal performs a cooperated communication determination/adjustment process based on the cooperated communication information retrieved by the base stations A, B, C, thus determining a communication method for the user terminal which is a source of sending a cooperated communication request.

In step S7, the user terminal communicates with the base station in accordance with the communication method which is determined in step S6.

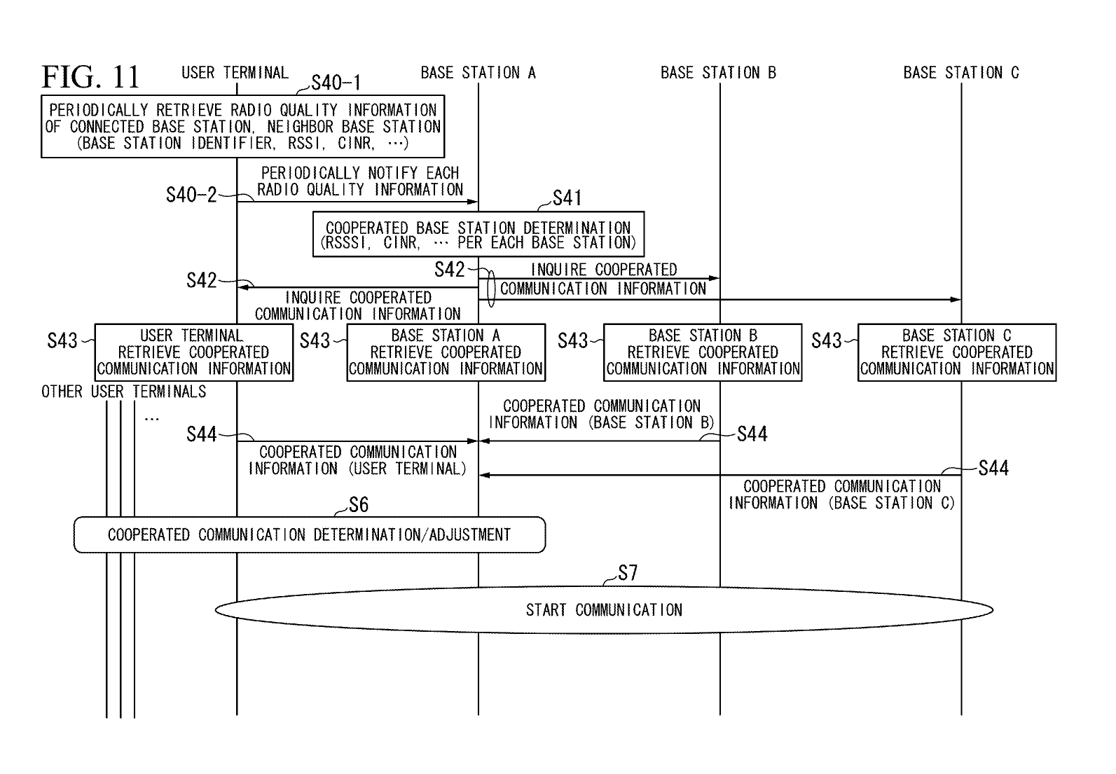

FIG. 11 is a sequence diagram showing another procedure of initiating interstation-cooperated communication. Similar to FIG. 10, FIG. 11 shows a procedure of initiating interstation-cooperated communication with the base stations A, B, C when the user terminal, which is currently communicating with the base station A alone, moves into the common boundary among the cells of the three base stations A, B, C. The procedure of FIG. 11 is basically identical to that of FIG. 10 except that the procedure of FIG. 10 causes the user terminal to request interstation-cooperated communication, whilst the procedure of FIG. 11 causes the base station to request interstation-cooperated communication. Hereinafter, another procedure of initiating interstation-cooperated communication will be described with reference to FIG. 11.

In step S40-1, the user terminal periodically measures radio quality information per each base station.

In step S40-2, the user terminal periodically sends radio quality information to the base station A.

In step S41, the base station A makes a decision whether to request the base stations A, B, C to serve as candidates for conducting interstation-cooperated communication with the user terminal. The decision criterion is identical to the decision criterion of step S1 in FIG. 5.

In step S42, the base station A inquires the user terminal and the base stations B, C, which are related to a request of interstation-cooperated communication, about cooperated communication information. As an inquiry of cooperated communication information for the base stations B, C, radio quality information of each base station and information regarding the MIMO mode are sent to the base stations B, C.

As an inquiry of interstation-cooperated communication for the user terminal, a combination of base stations (i.e. base stations A, B, C) conducting interstation-cooperated communication, and information regarding the MIMO mode are sent to the user terminal.

In step S43, the user terminal and the base stations A, B, C retrieve their cooperated communication information. The cooperated communication information of the user terminal contains a processing load of the user terminal, and the latest radio quality information regarding each of base stations (i.e. base stations A, B, C) subjected to interstation-cooperated communication. The cooperated communication information of the base stations A, B, C contains vacant slots available for interstation-cooperated communication, the number of user terminals which are already determined in accordance with interstation-cooperated communication, a combination of base stations conducting interstation-cooperated communication, and information regarding a processing load of each base station.

In step S44, the user terminal and the base stations B, C send back their retrieved cooperated communication information to the base station A. Steps S6 and S7 are identical to those in FIG. 10.

[Cooperated Communication Determination/Adjustment Process on Interstation-Cooperated Communication (Step S6 in FIGS. 10 and 11)]

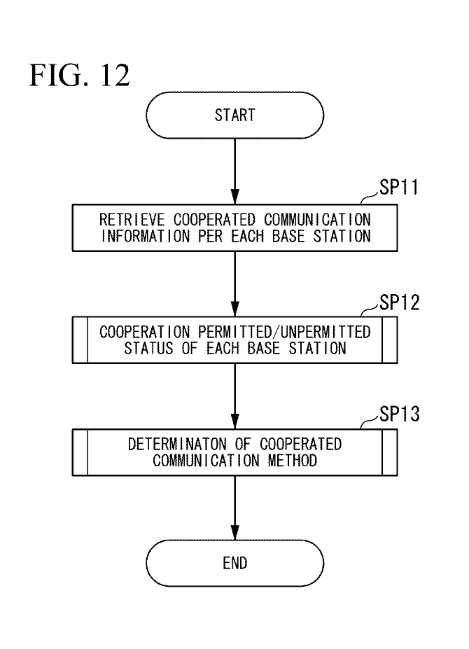

Next, a cooperated communication determination/adjustment process on interstation-cooperated communication with maximally three base stations will be described in conformity with step S6 in FIGS. 10 and 11. FIG. 12 is a flowchart of the cooperated communication determination/adjustment process in the base station A. Hereinafter, the cooperated communication determination/adjustment process will be described with reference to FIG. 12.

Step SP11 refers to retrieval of cooperated communication information of each base station conducting interstation-cooperated communication.

Step SP12 refers to a decision as to whether cooperation is permitted or unpermitted with respect to each base station based on the retrieved cooperated communication information.

Step SP13 refers to determination of a communication method based on the decision result on permitted/unpermitted cooperation. At this time, adjustment is made with another user terminal as necessary.

Next, step SP12 of FIG. 12 will be described in detail.

The base station A adopts a predetermined decision criterion to make a decision whether interstation-cooperated communication are permitted or unpermitted based on cooperated communication information relating to each of the base stations A, B, C. The base station A determines that interstation-cooperated communication are unpermitted when the decision result satisfies the following decision criteria (1), (2), (3), (4).

(1) The number of base stations involved in simultaneous controls of interstation-cooperated communication is four or more.
(2) It is impossible to additionally perform a process regarding interstation-cooperated communication with the foregoing user terminal since another user terminal has been already involved in interstation-cooperated communication.
(3) It is impossible to assign common vacant slots (radio resources) between base stations.
(4) The base station has already borne a high processing load.

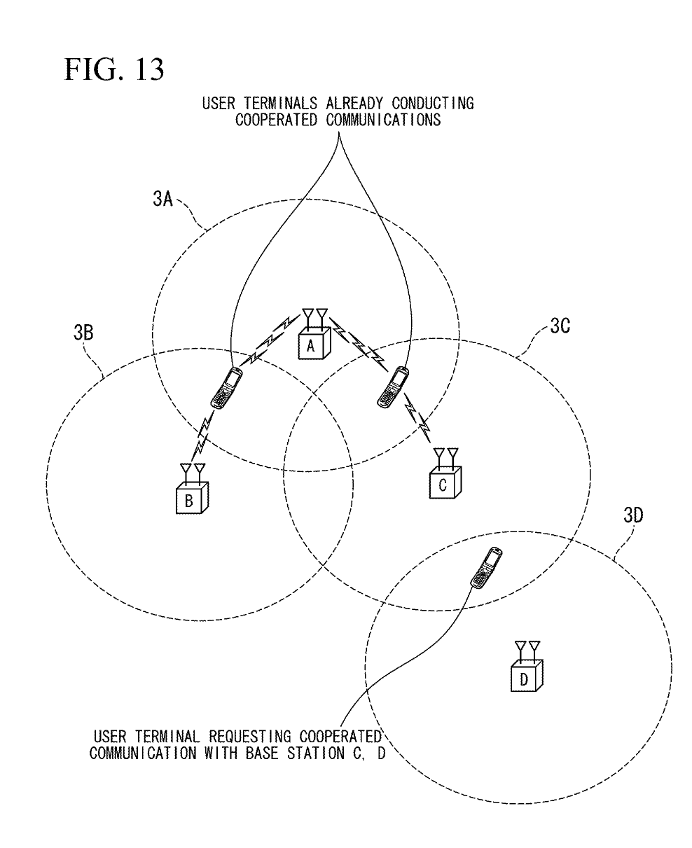

The decision criterion (1) will be described with reference to FIG. 13. Initially, it is presupposed that a pair of the base stations A, B and a pair of the base stations A, C have already conducted interstation-cooperated communication with the user terminal. At this time, the base station A serves as a common base stations for interstation-cooperated communication conducted between the base stations A, B and interstation-cooperated communication conducted between the base stations A, C. For this reason, their interstation-cooperated communication cannot be processed independently; hence, it is necessary to control interstation-cooperated communication among the base stations A, B, C. In this situation, when a new user terminal prefers interstation-cooperated communication with base stations C, D, it becomes necessary to newly control interstation-cooperated communication with the base station D; hence, the number of base stations subjected to interstation-cooperated communication becomes four in total. This situation matches the decision criterion (1), so that cooperation is unpermitted for the new user terminal which prefers interstation-cooperated communication with the base stations C, D. The situation matching the decision criterion (2) is equivalent to the first embodiment shown in FIG. 9.

Next, step SP13 of FIG. 12 will be described in detail.

Based on the result of step SP12, the base station A selects one cooperation permitted/unpermitted pattern from among eight combinations of permitted/unpermitted cooperated communication shown in Table 2 (i.e. cooperation permitted/unpermitted patterns (I), (II), (III), (IV), (V), (VI), (VII), (VIII)). The base station A performs an adjustment process according to the selected cooperation permitted/unpermitted pattern.

TABLE 2

| Cooperation | | | |
|---|---|---|---|
| permitted/unpermitted | | | |
| patterns | Base station A | Base station B | Base station C |
| (I) | Permitted | Permitted | Permitted |
| (II) | Permitted | Permitted | Unpermitted |
| (III) | Permitted | Unpermitted | Permitted |
| (IV) | Permitted | Unpermitted | Unpermitted |
| (V) | Unpermitted | Permitted | Permitted |
| (VI) | Unpermitted | Permitted | Unpermitted |
| (VII) | Unpermitted | Unpermitted | Permitted |
| (VIII) | Unpermitted | Unpermitted | Unpermitted |

Hereinafter, a series of operations according to cooperation permitted/unpermitted patterns will be described.

(I) Base Station A: Cooperation Permitted Status, Base Station B: Cooperation Permitted Status, Base Station C: Cooperation Permitted Status

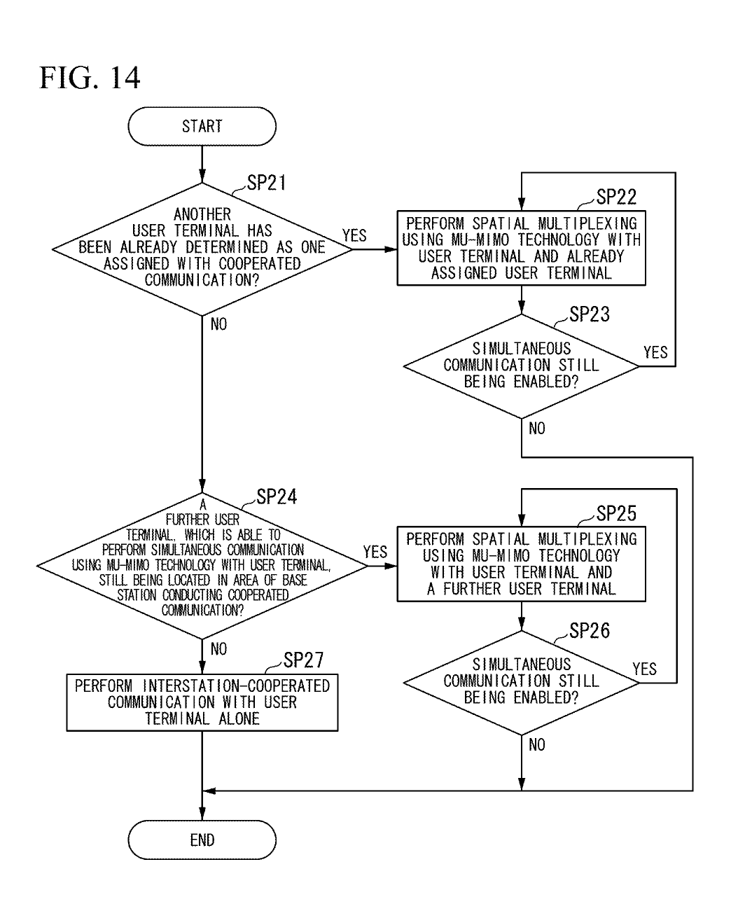

When all the base stations A, B, C are permitted to cooperate together with the user terminal, the base station A performs a process shown in FIG. 14. FIG. 14 is a flowchart showing an example of a cooperated communication determination/adjustment process on interstation-cooperated communication. Hereinafter, the cooperated communication determination/adjustment process according to the cooperation permitted/unpermitted pattern (I) of Table 2 with reference to FIG. 14.

In step SP21, the base station A checks whether or not another user terminal, other than the foregoing user terminal, is subjected to interstation-cooperated communication with the base stations A, B, C, which are determined in advance.

In step SP22, when another user terminal, other than the foregoing user terminal, is subjected to interstation-cooperated communication with the base stations A, B, C, which are determined in advance (YES in step SP21), the base station A determines that simultaneous communication is performed using spatial multiplexing with the foregoing user terminal and another user terminal

In step SP23, the base station A checks whether or not it still embraces a further user terminal subjected to simultaneous communication. When the checking result shows that the base station A still embraces a further user terminal subjected to simultaneous communication (YES in step SP23), the flow returns to step SP22. In contrast, when the base station A does not embrace a further user terminal subjected to simultaneous communication (NO in step SP23), the base station A exits the process of FIG. 14.

In step SP24, when no other user terminals, other than the foregoing user terminal, are subjected to interstation-cooperated communication with the base stations A, B, C, which are determined in advance (NO in step SP21), the base station A checks whether or not another user terminal, which can be subjected to simultaneous communication using the MU-MIMO technology, with the foregoing user terminal, is found among other user terminals located in any one of cells of the base stations A, B, C (or any one of overlapped regions between the cells of the base stations A, B, C).

In step SP25, when another user, which can be subjected to simultaneous communication with the foregoing user terminal, is found (YES in step SP24), the base station A determines that simultaneous communication is performed using spatial multiplexing with the foregoing user terminal and another user terminal in accordance with the MU-MIMO technology.

In step SP26, the base station A checks whether or not a further user terminal can be subjected to simultaneous communication. When the checking result shows that the base station A still embraces a further user terminal subjected to simultaneous communication (YES in step SP26), the flow returns to step SP25. In contrast, when the base station A does not embrace a further user terminal subjected to simultaneous communication (NO in step SP26), the base station A exits the process of FIG. 14.

In step SP27, when another user terminal subjected to simultaneous communication is not found (NO in step SP24), the base station A decides to conduct interstation-cooperated communication with the user terminal alone without using the MU-MIMO technology.

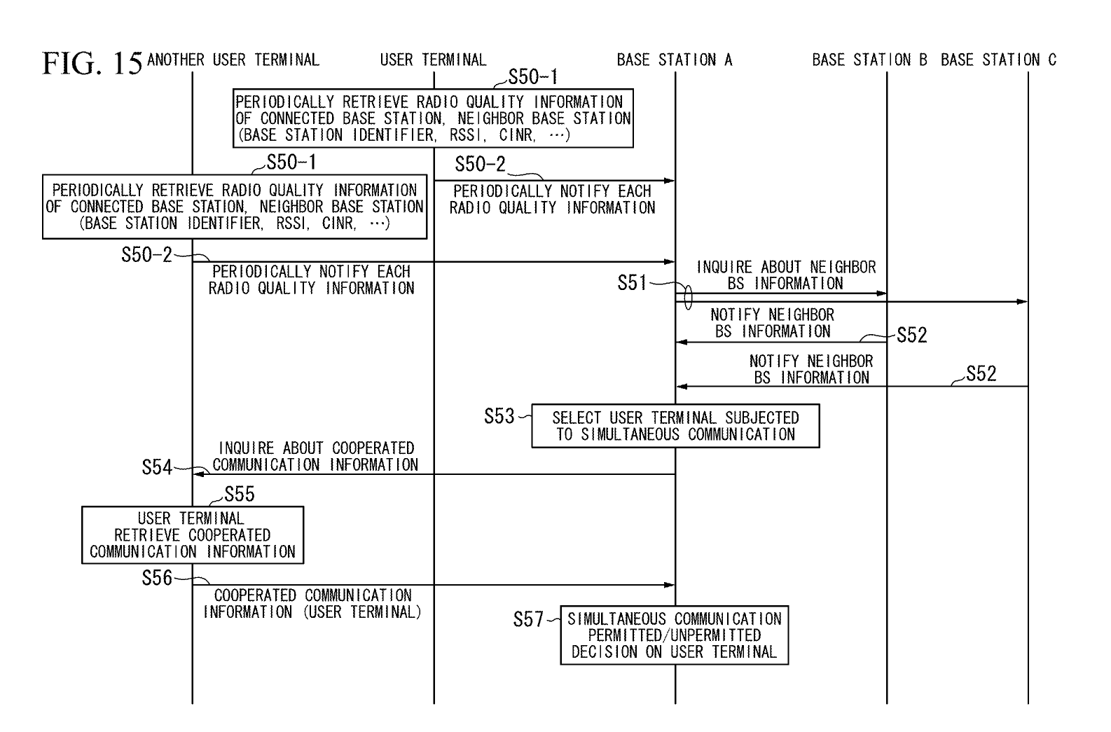

FIG. 15 is a sequence diagram showing a simultaneous communication adjustment process in steps SP23, SP24, SP26. The simultaneous communication adjustment process will be described with reference to FIG. 15.

In step SP50-1, each user terminal periodically measures radio quality information per each base station.

In step SP50-2, each user terminal periodically sends radio quality information to the base station A.

In step SP51, the base station A inquires the base stations B, C about neighbor BS information.

In step SP52, the base stations B, C sends back their neighbor BS information to the base station A.

In step SP53, the base station A selects another user terminal, which needs to perform simultaneous communication with the foregoing user terminal subjected to interstation-cooperated communication, based on the neighbor BS information of the base station A and the received neighbor BS information from the base stations B, C. For instance, the base station A selects another user terminal, which performs simultaneous communication, on the condition that the reception power from the base stations A, B, C does not greatly differ from the reception power of the foregoing user terminal, and interstation-cooperated communication are permitted among the base stations A, B, C.

In step SP54, the base station A inquires another user terminal, which is selected in step SP53, about cooperated communication information.

In step SP55, another user terminal, which receives an inquiry about cooperated communication information, retrieves cooperated communication information.

In step SP56, another user terminal sends back the retrieved cooperated communication information to the base station A.

In step SP57, the base station A makes a decision as to whether simultaneous communication are permitted or unpermitted with the foregoing user terminal based on the cooperated communication information from another user terminal

When another user terminal, which is selected in step SP53, is able to implement communication with the base station B or the base station C alone, before execution of step SP54, the base station A requests the communication-implemented base station to process the information of another user terminal and to make a decision as to whether cooperated communication is permitted or unpermitted after step SP54 and onwards.

(II) Base Station A: Cooperation Permitted Status, Base Station B: Cooperation Permitted Status, Base Station C: Cooperation Unpermitted Status

When the base station A has a cooperation permitted status, the base station B has a cooperation permitted status, but the base station C has a cooperation unpermitted status in connection with the user terminal, either the next process (II-1) or (II-2) is implemented.

Process (II-1): The base station A determines that two base stations A, B conduct interstation-cooperated communication via a multi-site connection with the user terminal. The base station A notifies the base station C of its decision to conduct interstation-cooperated communication with two base stations A, B via a multi-site connection with the user terminal.

To establish a single-site connection with another user terminal, located close to the base station C, in a radio resource slot enabling the foregoing user terminal to perform communication, and to suppress interference occurring in the foregoing user terminal establishing a multi-site connection with the base stations A, B, the base station C reduces its transmission power in communication. Alternatively, the base station C adopts the beam forming technology to nullify the direction for the foregoing user terminal establishing a multi-site connection with the base stations A, B and to communicate with another user terminal, which is able to establish a single-site connection with the base station C, by way of the beam shaping.

Process (II-2): The base station A determines that the user terminal will establish a single-site connection with either the base station A or B. For instance, the user terminal establishes a single-site connection with the base station A. In this case, the base station A notifies the base stations B, C of its decision to communicate with the foregoing user terminal via a single-site connection. To establish a single-site connection with another user terminal, located close the base stations B, C, in a radio resource slot enabling the foregoing user terminal to perform communication, and to suppress interference occurring in the foregoing user terminal establishing a single-site connection with the base station A, the base stations B, C reduce their transmission powers in communication. Alternatively, the base stations B, C adopts the beam forming technology to nullify the direction for the foregoing user terminal establishing a single-site connection with the base station A and to communicate with another user terminal, which is able to establish a single-site connection with the base stations B, C, by way of the beam shaping.

(III) Base Station A: Cooperation Permitted Status, Base Station B: Cooperation Unpermitted Status, Base Station C: Cooperation Permitted Status

When the base station A has a cooperation permitted status, the base station B has a cooperation unpermitted status, and the base station C has a cooperation permitted status in connection with the user terminal, either the next process (III-1) or (III-2) is implemented.

Process (III-1): The base station A determines that two base stations A, C conduct interstation-cooperated communication via a multi-site connection with the foregoing user terminal. The base station A notifies the base station B of its decision of conducting interstation-cooperated communication with two base stations via a multi-site connection with the foregoing user terminal.

To establish a single-site connection with another user terminal, located close to the base station B, in a radio resource slot, enabling the foregoing user terminal to perform communication, and to suppress interference occurring in the foregoing user terminal establishing a multi-site connection with the base stations A, C, the base station B reduces its transmission power in communication. Alternatively, the base station B adopts the beam forming technology to nullify the direction for the foregoing user terminal establishing a multi-site communication with the base stations A, C and to communicate with another user terminal, which is able to establish a single-site connection with the base station B, by way of the beam shaping.

Process (III-2): The base station A determines that the foregoing user terminal establishes a single-site connection with either the base station A or C. For instance, the foregoing user terminal establishes a single-site connection with the base station A. In this case, the base station A notifies the base stations B, C of its decision to communication with the foregoing user terminal via a single-site connection. To establish a single-site connection with another user terminal, located close to the base stations B, C, in a radio resource slot enabling the foregoing user terminal to perform communication and to suppress interference occurring in the foregoing user terminal establishing a single-site connection with the base station A, the base stations B, C reduce their transmission power in communication. Alternatively, the base stations B, C adopt the beam forming technology to nullify the direction for the foregoing user terminal establishing a single-site connection with the base station A and to communicate with another user terminal, which is able to establish a single-site connection with the base stations B, C, by way of the beam shaping.

(IV) Base Station A: Cooperated Permitted Status, Base Station B: Cooperation Unpermitted Status, Base Station C: Cooperation Unpermitted Status

When the base station A has a cooperation permitted status, the base station B has a cooperation unpermitted status, and the base station C has a cooperation unpermitted status in connection with the user terminal, the base station A decides to establish a single-site connection with the foregoing user terminal. The base station A notifies the base stations B, C of its decision to communicate with the foregoing user terminal via a single-site connection. To establish a single-site connection with another user terminal, located close to the base stations B, C, in a radio resource slot enabling the foregoing user terminal to perform communication and to suppress interference occurring in the foregoing user terminal establishing a single-site connection with the base station A, the base stations B, C reduce their transmission power in communication. Alternatively, the base stations B, C adopt the beam forming technology to nullify the direction for the foregoing user terminal establishing a single-site connection with the base station A and to communication with another user terminal, which is able to establish a single-site connection with the base stations B, C, by way of the beam shaping.

(V) Base Station A: Cooperation Unpermitted Status, Base Station B: Cooperation Permitted Status, Base Station C: Cooperation Permitted Status

When the base station A has a cooperation unpermitted status, the base station B has a cooperation permitted status, and the base station C has a cooperation permitted status in connection with the user terminal, one of the following processes (V-1), (V-2), and (V-3) is implemented.

Process (V-1): The base station A determines that the base stations B, C conduct interstation-cooperated communication via a multi-site connection with the foregoing user terminal. To establish a single-site connection with another user terminal, located close to the base station A, in a radio resource slot enabling the foregoing user terminal to perform communication and to suppress interference occurring in the foregoing user terminal establishing a multi-site connection with the base stations B, C, the base station A reduces its transmission power in communication. Alternatively, the base station A adopts the beam forming technology to nullify the direction for the foregoing user terminal establishing a multi-site connection with the base stations B, C and to communicate with another user terminal, which is able to establish a single-site connection with the base station A, by way of the beam shaping.

Process (V-2): The base station A decides to establish a single-site connection with the foregoing user terminal. The base station A notifies the base stations B, C of its decision to communicate with the foregoing user terminal via a single-site connection. To establish a single-site connection with another user terminal, located close to the base stations B, C, in a radio resource slot enabling the foregoing user terminal to perform communication and to suppress interference occurring in the foregoing user terminal establishing a single-site connection with the base station A, the base stations B, C reduce their transmission power in communication. Alternatively, the base stations B, C adopts the beam forming technology to nullify the direction for the foregoing user terminal establishing a single-site connection with the base station A and to communicate with another user terminal, which is able to establish a single-site connection with the base stations B, C, by way of the beam shaping.

Process (V-3): The base station A determines that the foregoing user terminal establishes a single-site connection with either the base station B or C. This is because the base station A, which the foregoing user terminal belongs to, bears a high processing load owing to the cooperation unpermitted status thereof, wherein it is expected that the foregoing user terminal can improve communication quality by establishing a single-site connection with the base station B or C. For instance, the foregoing user terminal establishes a single-site connection with the base station B. In this case, the base station A requests the base station B to establish a single-site connection with the foregoing user terminal. In response to a request from the base station A, the base station B notifies the base station A of its decision to communicate with the foregoing user terminal via a single-site connection. The base station A notifies the base station C of the decision that the foregoing user terminal communicates with the base station B via a single-site connection. To establish a single-site connection with another user terminal, located close to the base stations A, C, in a radio resource slot enabling the foregoing user terminal to perform communication and to suppress interference occurring in the foregoing user terminal establishing a single-site connection with the base station B, the base stations A, C reduce their transmission power in communication. Alternatively, the base stations A, C adopt the beam forming technology to nullify the direction for the foregoing user terminal establishing a single-site connection with the base station B and to communicate with another user terminal, which is able to establish a single-site connection with the base stations A, C, by way of the beam shaping.

(VI) Base Station A: Cooperation Unpermitted Status, Base Station B: Cooperation Permitted Status, Base Station C: Cooperation Unpermitted Status

When the base station A has a cooperation unpermitted status, the base station B has a cooperation permitted status, and the base station C has a cooperation unpermitted status in connection with the foregoing user terminal, either the next process (VI-1) or (VI-2) is implemented.

Process (VI-1): Similar to the process (V-2), the base station A decides to establish a single-site connection with the foregoing user terminal. This process is identical to the process (V-2).

Process (VI-2): The base station A determines that the foregoing user terminal establishes a single-site connection with the base station B. The subsequent process is identical to the process (V-3).

(VII) Base Station A: Cooperation Unpermitted Status, Base Station B: Cooperation Unpermitted Status, Base Station C: Cooperation Permitted Status

When the base station A has a cooperation unpermitted status, the base station B has a cooperation unpermitted status, and the base station C has a cooperation permitted status in connection with the foregoing user terminal, either the next process (VII-1) or (VII-2) is implemented.

Process (VII-1): Similar to the process (V-2), the base station A decides to establish a single-site connection with the foregoing user terminal. This process is identical to the process (V-2).

Process (VII-2): The base station A determines that the foregoing user terminal establishes a single-site connection with the base station C. The subsequent process is identical to the process (V-3). The difference compared to process (VI-2) is that the base station establishing a single-site connection is the base station C.

(VIII) Base Station A: Cooperation Unpermitted Status, Base Station B: Cooperation Unpermitted Status, Base Station C: Cooperation Unpermitted Status

When all the base stations A, B, C have cooperation unpermitted statuses in connection with the foregoing user terminal, the base station A operates similarly to process (V-2) to decide to establish a single-site connection with the foregoing user terminal. This process is identical to process (V-2).

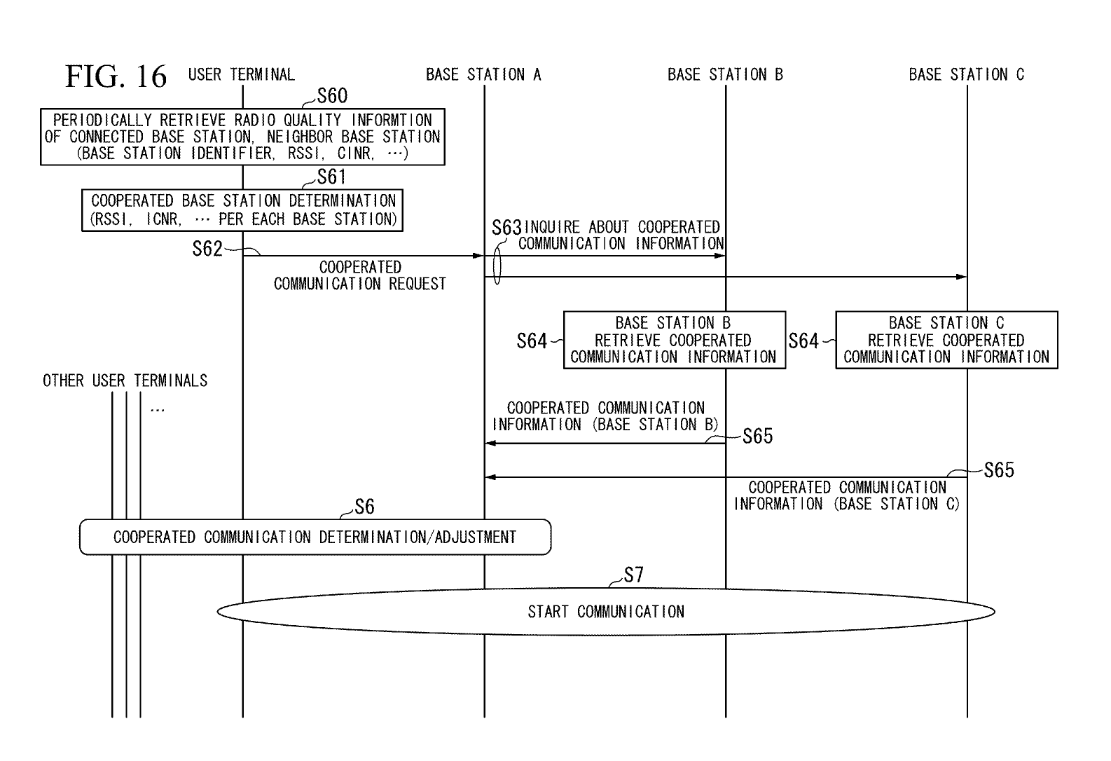

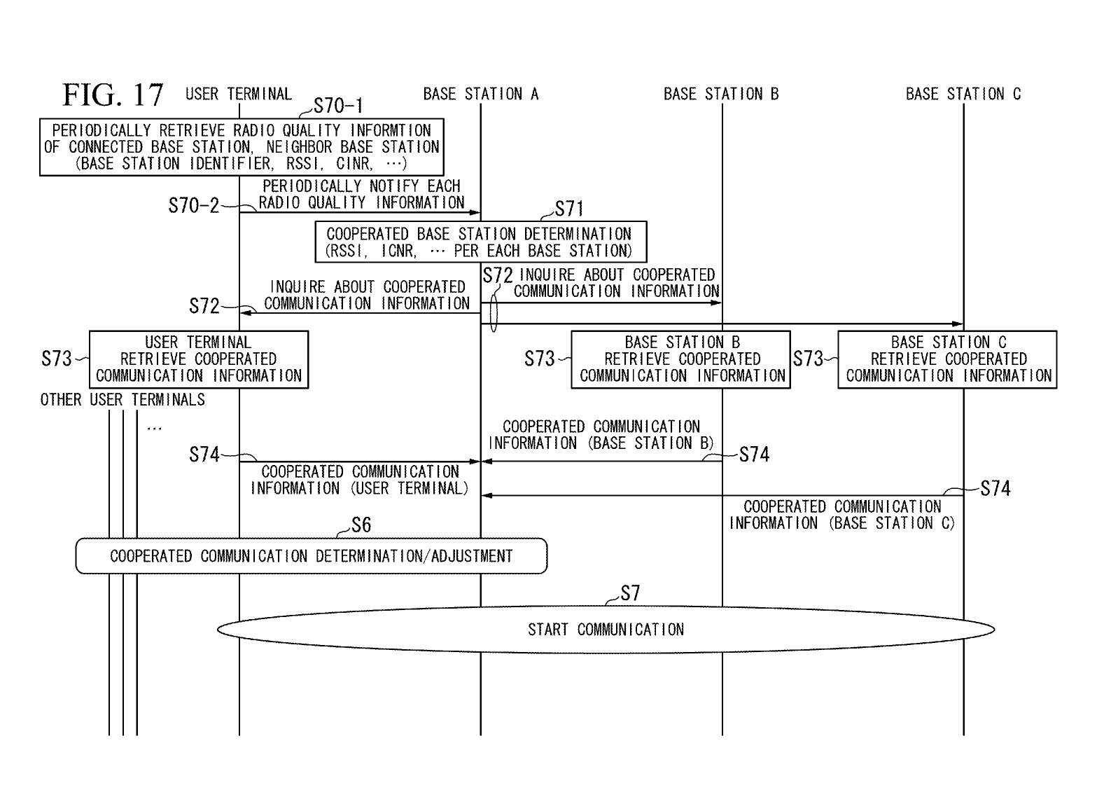

Although the second embodiment implements interstation-cooperated communication with three base stations A, B, C, this constitution enables two base stations to conduct interstation-cooperated communication. FIGS. 16 and 17 are sequence diagrams showing procedures of initiating interstation-cooperated communication when the user terminal belonging to the base station A prefers interstation-cooperated communication with two base stations B, C. FIG. 16 is a sequence diagram in which the user terminal requests interstation-cooperated communication. FIG. 17 is a sequence diagram in which the base station A requests interstation-cooperated communication.

FIG. 16 differs from FIG. 10 in that the user terminal requests interstation-cooperated communication with the base stations B, C in step S62, and subsequent processing is performed based on the request, whereas FIG. 16 is identical to FIG. 10 in other processing; hence, its description will be omitted. FIG. 17 differs from FIG. 11 in that the base stations B, C are selected as candidates for conducting interstation-cooperated communication with the user terminal in step S71, and subsequent process is performed based on the request, whereas FIG. 17 is identical to FIG. 11 in other processing; hence, its description will be omitted.

### Third Embodiment

The third embodiment provides an interstation-cooperated communication process which is implemented after the first embodiment or the second embodiment starts communication (step S7). In step S7, the user terminal starts to communicate with the base station in accordance with the communication method, which is determined in the cooperated communication determination/adjustment process (step S6), wherein the third embodiment is implemented when the communication method indicates interstation-cooperated communication. Herein, the radio resource (slot), which is determined in the cooperated communication determination/adjustment process, is continuously used (reserved); but the utilization method of radio resources is not necessarily limited to this method. The third embodiment refers to the situation in which a single user terminal performs interstation-cooperated communication; however, the third embodiment is applicable to another situation in which a plurality of user terminals performs interstation-cooperated communication. Hereinafter, a series of operations implemented in the third embodiment will be described.

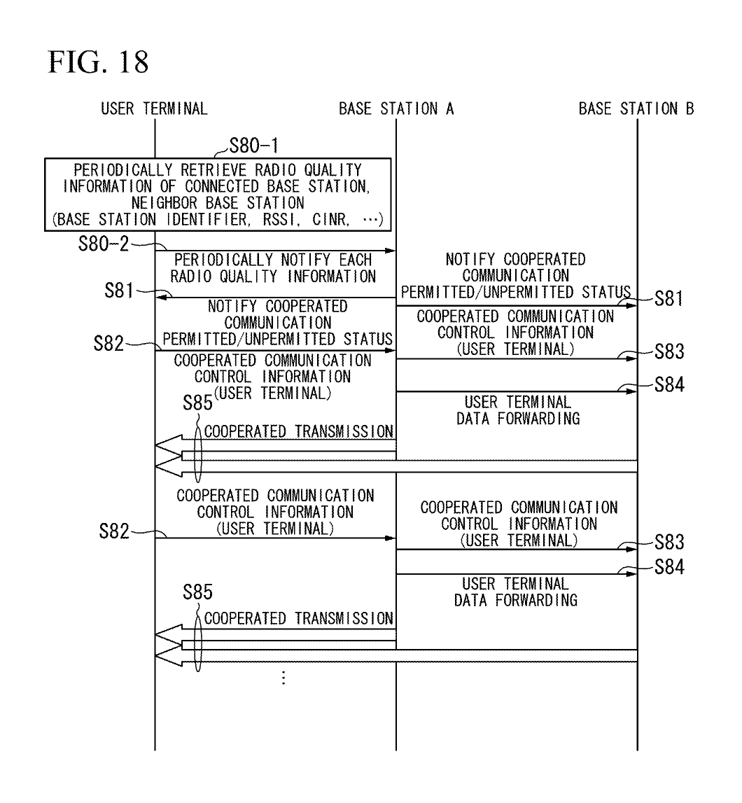

FIG. 18 is a sequence diagram showing a procedure of continuing interstation-cooperated communication. FIG. 18 refers to the procedure in which the user terminal, which has already been involved in interstation-cooperated communication with the base stations A, B, continues interstation-cooperated communication. Hereinafter, the procedure of continuing interstation-cooperated communication will be described with reference to FIG. 18.

In step S80-1, the user terminal periodically measures radio quality information per each base station.

In step S80-2, the user terminal periodically transmits radio quality information to the base station A. The transmitting period is independent of the period for transmitting interstation-cooperated communication, such as channel matrices, which are needed to continue interstation-cooperated communication, which will be described later.

In step S81, the base station A sends a cooperated communication permitted/unpermitted notification to the user terminal and the base station B. The cooperated communication permitted/unpermitted notification contains a statement of conducting interstation-cooperated communication, information for specifying the user terminal and the base station B involved in interstation-cooperated communication, and information of assigned radio resources.

In step S82, the user terminal sends cooperated communication control information to the base station A. The cooperated communication control information contains radio communication information, such as channel matrices, which is needed to conduct interstation-cooperated communication.

In step S83, the base station A forwards the cooperated communication control information, which the base station A receives from the user terminal, to the base station B.

In step S84, the base station A forwards transmitting data addressing the user terminal to the base station B. Data forwarded to the base station B comply with the MIMO mode. Specifically, when the MIMO mode defines the transmission diversity and spatial coding, the base station A sends a copy of transmitting data, which are transmitted via interstation-cooperated communication, to the base station B. When the MIMO mode defines the spatial multiplexing method, the base station A forwards transmitting data, which are spatially multiplexed, to the base station B in order to cause the base stations A, B to transmit their data independently.

The third embodiment refers to direct forwarding of data from the base station A to the base station B; but the data forwarding method is not necessarily limited to this method. For instance, the base station A may notifies the router 6, installed in the backbone network 4, to conduct interstation-cooperated communication so that the router 6 will copy transmitting data addressing the user terminal to perform bicasting on the base stations A, B or transmit spatially multiplexed transmitting data to the base stations A, B respectively.

In step S85, the base stations A, B conduct interstation-cooperated communication with the user terminal.

Hereinafter, a series of steps S82 to S85 is repeated to directly continue interstation-cooperated communication.

[Procedure of Decreasing the Number of Cooperated Base Stations]

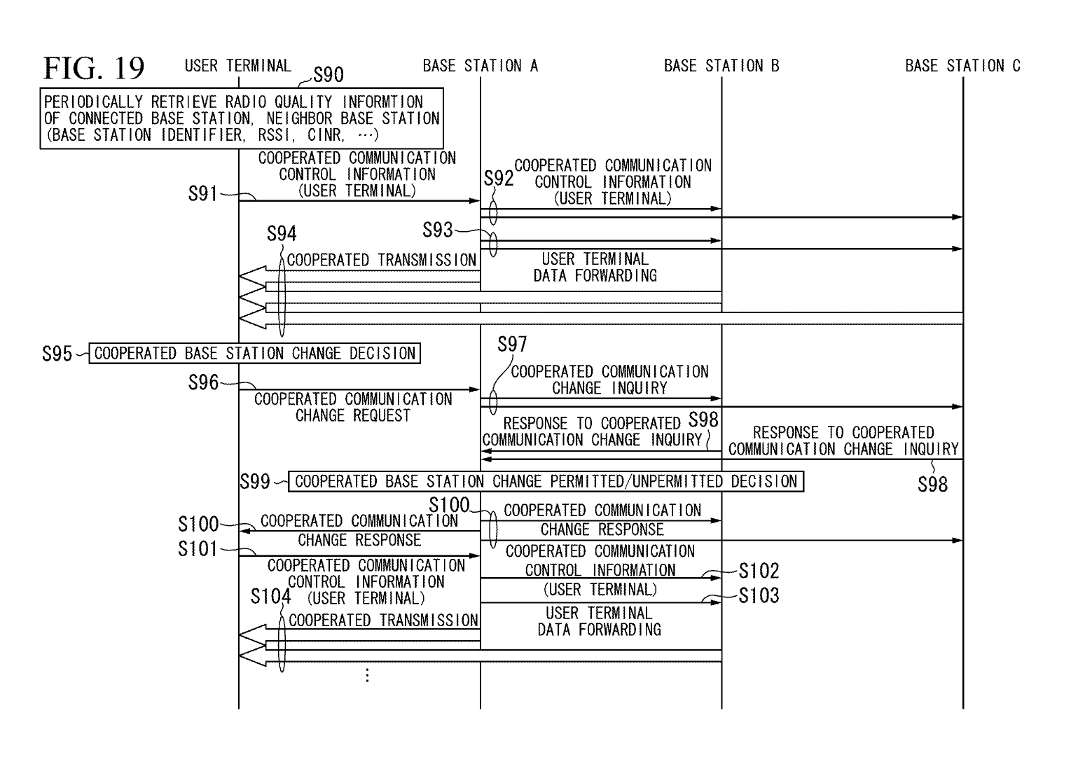

FIG. 19 is a sequence diagram showing a procedure of decreasing the number of base stations conducting interstation-cooperated communication. FIG. 19 refers to the procedure that the user terminal, which is currently involved in interstation-cooperated communication with three base stations A, B, C, changes its operation to conduct interstation-cooperated communication with the decreased number of cooperated base stations, i.e. two base stations. Hereinafter, the procedure of decreasing the number of cooperated base stations will be described with reference to FIG. 19.

In step S90, the user terminal periodically measures radio quality information per each base station.

In step S91, the user terminal sends cooperated communication control information to the base station A.

In step S92, the base station A forwards the cooperated communication control information, received from the user terminal, to the base stations B, C.

In step S93, the base station A forwards transmitting data addressing the user terminal to the base stations B, C.

In step S94, the base stations A, B, C conduct interstation-cooperated communication with the user terminal.

In step S95, the user terminal makes a decision, based on radio quality information, as to whether interstation-cooperated communication with three base stations A, B, C are changed to interstation-cooperated communication with two base stations A, B. As the decision criterion, for example, the user terminal precludes the base station C from the base stations conducting interstation-cooperated communication when values of RSSI and CINR from the base station C are greatly degraded compared to those from the other base stations A, B.

Since CINR values are calculated using carrier wave components defining signals of cooperated base stations, it is necessary to calculate CINR values per each combination of cooperated base stations.

In step S96, the user terminal sends a cooperated communication change request, indicating shifting to interstation-cooperated communication with two base stations A, B, to the base station A. The cooperated communication change request contains a current combination of cooperated base stations (i.e. base stations A, B, C), the current MIMO mode, a newly desired pair of cooperated base stations (i.e. base stations A, B), and information regarding the MIMO mode adopted in the new pair of cooperated base stations.

In step S97, the base station A receiving the cooperated communication change request sends a cooperated communication change inquiry to the base stations B, C. As the cooperated communication change inquiry, various pieces of information regarding the identifier of the user terminal, information included in the cooperated communication change request, and presently allocated slots (radio resource) are sent to the inquired base stations.

In step S98, the base stations B, C receiving the cooperated communication change inquiry makes a decision whether or not to change interstation-cooperated communication, thus responding to the base station A.

In step S99, the base station A makes a decision whether or not to change interstation-cooperated communication based on the status of the base station A and the response to the cooperated communication change inquiry from the base stations B, C.

In step S100, the base station A notifies the user terminal and the base stations B, C of a cooperated communication change response, i.e. the decision result whether or not to change interstation-cooperated communication. The cooperated communication change response contains various pieces of information regarding a new pair of cooperated base stations (i.e. base stations A, B), the MIMO mode, and allocated slots (radio resource).

In step S101, similar to step S91, the user terminal sends cooperated communication control information to the base station A.

In step S102, the base station A forwards the cooperated communication control information, received from the user terminal, to the base station B.

In step S103, the base station A forwards transmitting data addressing the user terminal to the base station B.

In step S104, the base stations A, B conduct interstation-cooperated communication with the user terminal.

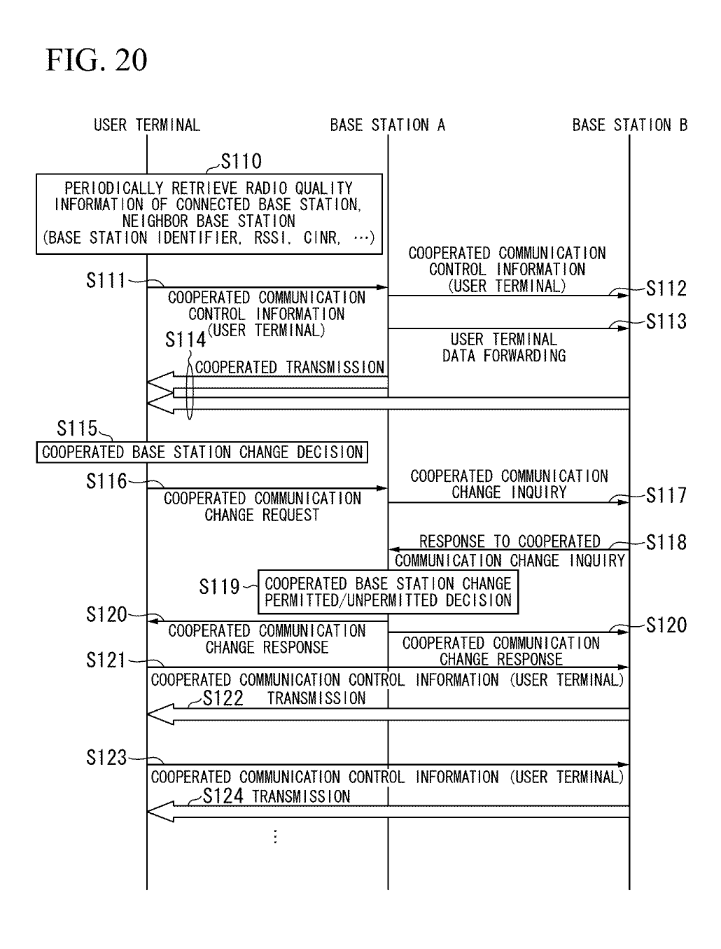

FIG. 20 is a sequence diagram showing another procedure of decreasing the number of base stations conducting interstation-cooperated communication. FIG. 20 refers to the procedure that the user terminal, which is presently involved in interstation-cooperated communication with two base stations A, B, changes it operation to establish a single-site connection with the base station B due to some reason such as movement.

Hereinafter, the procedure of decreasing the number of cooperated base stations will be described with reference to FIG. 20.

In step S110, the user terminal periodically measures radio quality information per each base station.

In step S111, the user terminal sends cooperated communication control information to the base station A.

In step S112, the base station A forwards the cooperated communication control information, received from the user terminal, to the base station B.

In step S113, the base station A forwards transmitting data addressing the user terminal to the base station B.

In step S114, the base stations A, B conduct interstation-cooperated communication with the user terminal.

In step S115, the user terminal makes a decision, based on radio quality information, as to whether interstation-cooperated communication with two base stations A, B are changed to a single-site connection with the base station B. As the decision criterion, for example, the user terminal decides to change interstation-cooperated communication to a single-site connection with the base station B when values of RSSI and CINR of the base station A are greatly degraded compared to those of the base station B. Since CINR values are calculated using carrier wave components defining signals of cooperated base stations, it is necessary to calculate CINR values per each combination of cooperated base stations.

In step S116, the user terminal sends a cooperated communication change request, indicating shifting to a single-site connection with the base station B, to the base station A. The cooperated communication change request contains various pieces of information regarding the current pair of cooperated base stations (i.e. base stations A, B), the current MIMO mode, a newly desired connected base station (i.e. the base station B), and the MIMO mode adopted in the newly connected base station.

In step S117, the base station A receiving the cooperated communication change request sends a cooperated communication change inquiry to the base station B. As the cooperated communication change inquiry, various pieces of information regarding the identifier of the user terminal, information included in the cooperated communication change request, and currently allocated slots (radio resource regions) are sent to the inquired base station.

In step S118, the base station B receiving the cooperated communication change inquiry makes a decision whether or not to change interstation-cooperated communication, thus responding to the base station A.

In step S119, the base station A makes a decision whether or not to change interstation-cooperated communication based on the status of the base station A and the response to the cooperated communication change inquiry from the base station B.

In step S120, the base station A notifies the user terminal and the base station B of a cooperated communication change response, i.e. the decision result whether or not to change interstation-cooperated communication. The cooperated communication change response contains various pieces of information regarding the newly connected base station (i.e. the base station B), the MIMO mode, and allocated slots (radio resource regions).

In step S121, the user terminal sends cooperated communication control information to the base station B involving a single-site connection.

In step S122, the base station B communicates with the user terminal via a single-site connection.

Hereinafter, a series of steps S121 and S122 is repeated (see S123, S124, . . . ).

The procedure of decreasing the number of cooperated base stations shown in FIG. 20 causes handover from the base station A, which the user terminal belongs to, to the base station B, so that a procedure of changing the base station assigned to the user terminal is implemented in the backbone network. Therefore, after shifting to a single-site connection, the user terminal is assigned to the base station B, so that transmitting data addressing the user terminal are directly transmitted from the base station B to the user terminal without passing by the base station A.

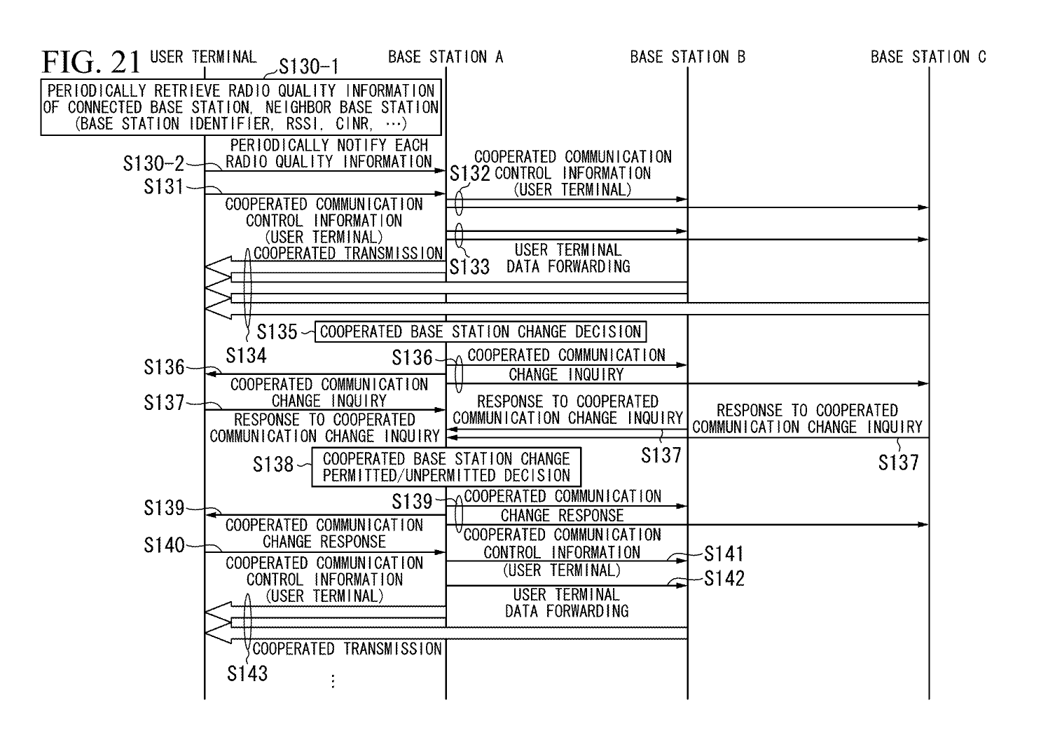

FIG. 21 is a sequence diagram showing another procedure of decreasing the number of base stations conducting interstation-cooperated communication. Similar to FIG. 19, FIG. 21 shows the procedure that the user terminal, which is currently involved in interstation-cooperated communication with three base stations A, B, C, changes it operation to conduct interstation-cooperated communication with the reduced number of base stations, i.e. two base stations. The procedure of FIG. 21 is identical to the procedure of FIG. 19 except that the procedure of FIG. 19 causes the user terminal to issue an interstation-cooperated communication change request whilst the procedure of FIG. 21 causes the base station to issue an interstation-cooperated communication change request. Hereinafter, the procedure of decreasing the number of cooperated base stations with reference to FIG. 21.

In step S130-1, the user terminal periodically measures radio quality information per each base station.

In step S130-2, the user terminal periodically sends radio quality information to the base station A.

In step S131, the user terminal sends cooperated communication control information to the base station A.

In step S132, the base station A forwards the cooperated communication control information, received from the user terminal, to the base stations B, C.

In step S133, the base station A forwards transmitting data addressing the user terminal to the base stations B, C.

In step S134, the base stations A, B, C conduct interstation-cooperated communication with the user terminal.

In step S135, the base station A makes a decision, based on radio quality information, whether to change interstation-cooperated communication with three base stations A, B, C to interstation-cooperated communication with two base stations A, B. The decision criterion is identical to step S95 in FIG. 19.

In step S136, the base station A sends a cooperated communication change inquiry to the user terminal and the base stations B, C. As the cooperated communication change inquiry, various pieces of information regarding the identifier of the user terminal, a current combination of cooperated base stations (i.e. base stations A, B, C), the currently adopted MIMO mode, a newly desired pair of cooperated base stations (i.e. base stations A, B), the MIMO mode adopted in the new pair of cooperated base stations, and currently allocated slots (radio resource) are sent to the inquired user terminal and the inquired base stations.

In step S137, the user terminal and the base stations B, C, both receiving the cooperated communication change inquiry, makes a decision whether or not to change interstation-cooperated communication, thus responding to the base station A.

In step S138, the base station A makes a decision whether or not to change interstation-cooperated communication based on the status of the base station A as well as responses to the cooperated communication change inquiry from the user terminal and the base stations B, C.

Subsequent steps S139 to S143 are identical to steps S100 to S104 in FIG. 19.

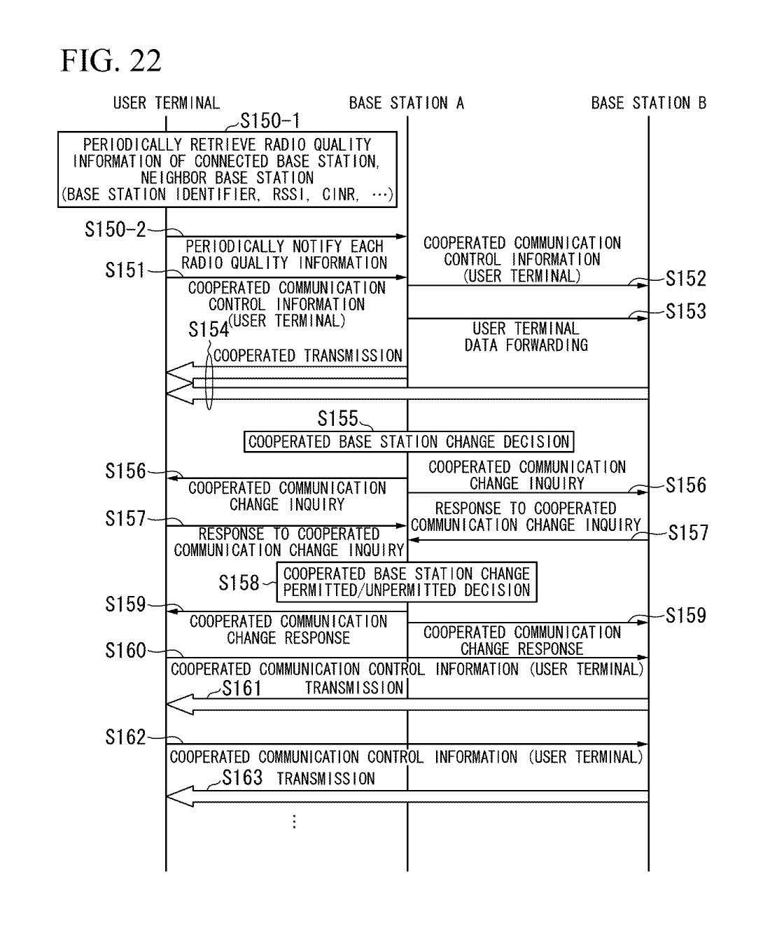

FIG. 22 is a sequence diagram showing a further procedure of decreasing the number of base stations conducting interstation-cooperated communication. FIG. 22 shows the procedure that the user terminal, which is currently involved in interstation-cooperated communication with two base stations A, B, changes its operation to establish a single-site connection with the base station B due to movement. Hereinafter, the further procedure of decreasing the number of cooperated base stations will be described with reference to FIG. 22.

In step S150-1, the user terminal periodically measures radio quality information per each base station.

In step S150-2, the user terminal periodically sends radio quality information to the base station A.

In step S151, the user terminal sends cooperated communication control information to the base station A.

In step S152, the base station A forwards the cooperated communication control information, received from the user terminal, to the base station B.

In step S153, the base station A forwards transmitting data addressing the user terminal to the base station B.

In step S154, the base stations A, B conduct interstation-cooperated communication with the user terminal.

In step S155, the base station A makes a decision, based on radio quality information, whether to change interstation-cooperated communication with two base stations A, B to a single-site connection with the base station B. The decision criterion is identical to step S115 in FIG. 20.

In step S156, the base station A sends a cooperated communication change inquiry, indicating shifting to a single-site connection with the base station B, to the user terminal and the base station B. As the cooperated communication change inquiry, various pieces of information regarding the identifier of the user terminal, a current pair of cooperated base stations (i.e. base stations A, B), the current MIMO mode, a newly desired connected base station (i.e. the base station B), the MIMO mode for the newly connected base station, and currently allocated slots (radio resource) are sent to the inquired user terminal and the inquired base station.

In step S157, the user terminal and the base station B, both receiving the cooperated communication change inquiry, makes a decision whether or not to change interstation-cooperated communication, thus responding to the base station A.

In step S158, the base station A makes a decision whether or not to change interstation-cooperated communication based on the status of the base station A as well as responses to the cooperated communication change inquiry from the user terminal and the base station B,

Subsequent steps S159 to S163 are identical to steps S120 to S124 in FIG. 20.

The procedure of decreasing the number of cooperated base stations shown in FIG. 22 is involved in a handover for changing the base station assigned to the user terminal from the base station A to the base station B; hence, a procedure of changing the assigned base station of the user terminal is implemented in the backbone network. Therefore, the user terminal belongs to the base station B after shifting to a single-site connection, so that transmitting data addressing the user terminal are directly transmitted from the base station B to the user terminal without passing by the base station A.

[Procedure of Increasing the Number of Cooperated Base Stations]

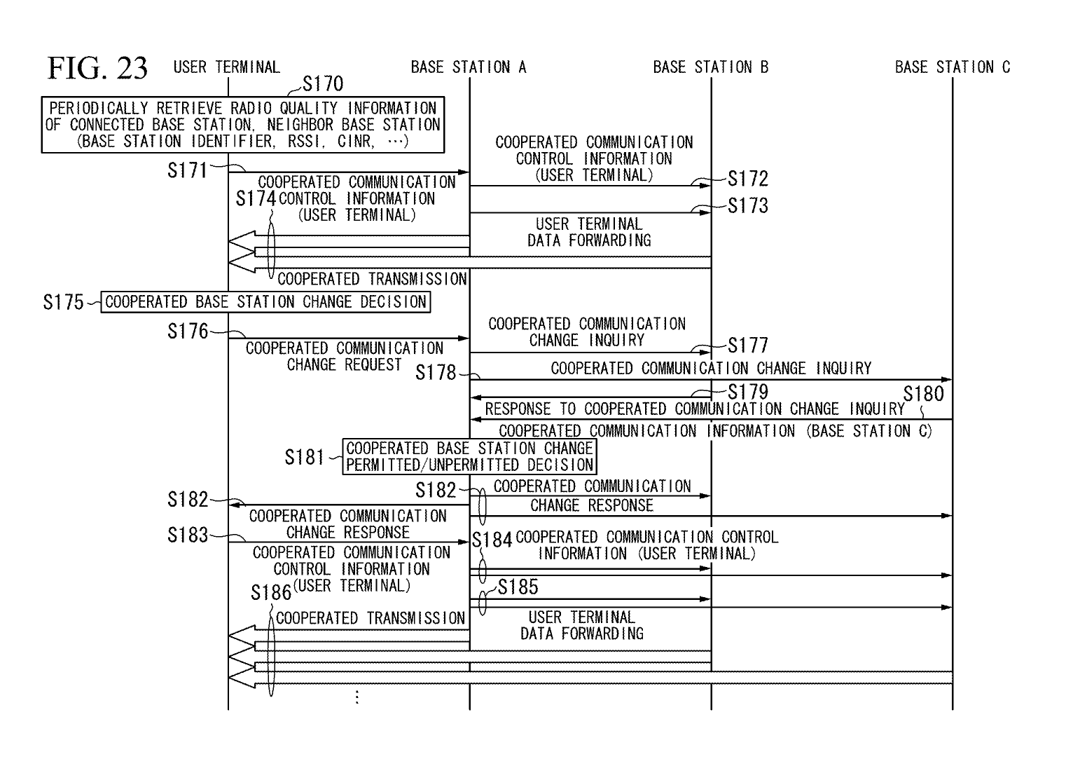

FIG. 23 is a sequence diagram showing a procedure of increasing the number of base stations conducting interstation-cooperated communication. FIG. 23 shows the procedure that the user terminal, which is currently involved in interstation-cooperated communication with two base stations A, B, changes it operation to conduct interstation-cooperated communication with the increased number of cooperated base stations, i.e. three base stations A, B, C. Hereinafter, the procedure of increasing the number of cooperated base stations will be described with reference to FIG. 23.

In step S170, the user terminal periodically measures radio quality information per each base station.

In step S171, the user terminal sends cooperated communication control information to the base station A.

In step S172, the base station A forwards the cooperated communication control information, received from the user terminal, to the base station B.

In step S173, the base station A forwards transmitting data addressing the user terminal to the base station B.

In step S174, the base stations A, B conduct interstation-cooperated communication with the user terminal.

In step S175, the user terminal makes a decision, based on radio quality information, whether to change interstation-cooperated communication with two base stations A, B to interstation-cooperated communication with three base stations A, B, C. The decision criterion indicates that the base station C can be incorporated into interstation-cooperated communication, for example, when values of RSSI and CINR of the base station C are improved and comparable to those of the base stations A, B. Since CINR values are calculated using carrier wave components defining signals of cooperated base stations, it is necessary to calculate CINR values per each combination of cooperated base stations.

In step S176, the user terminal sends a cooperated communication change request, indicating shifting to interstation-cooperated communication with three base stations A, B, C, to the base station A. The cooperated communication change request contains various pieces of information regarding a current pair of cooperated base stations (i.e. base stations A, B), the current MIMO mode, a newly desired combination of cooperated base stations (i.e. base stations A, B, C), and the MIMO mode adopted in the new combination of cooperated base stations.

In step S177, the base station A receiving the cooperated communication change request sends a cooperated communication change inquiry to the base station B. As the cooperated communication change inquiry, various pieces of information regarding the identifier of the user terminal, information included in the cooperated communication change request, currently allocated slots (radio resource regions) are sent to the inquired base station.

In step S178, the base station A sends inquires the base station C about cooperated communication information. As the inquiry of cooperated communication information, various pieces of information regarding the MIMO mode received from the user terminal as well as the radio quality information and the processing load per each base station are sent to the inquired base station.

In step S179, the base station B receiving the cooperated communication change inquiry makes a decision whether or not to change interstation-cooperated communication, thus responding to the base station A.

In step S180, the base station C sends back cooperated communication information to the base station A. The cooperated communication information contains various pieces of information regarding vacant slots available for interstation-cooperated communication, the number of user terminals, which have been already determined in accordance with interstation-cooperated communication, a pair of base stations conducting interstation-cooperated communication with the user terminal, and a processing load of the currently assigned base station.

In step S181, the base station A makes a decision whether or not to change interstation-cooperated communication based on the status of the base station A, the response to the cooperated communication change inquiry from the base station B, and the cooperated communication information from the base station C. At this time, it is possible to adjust allocated slots during allocation of radio recourses when vacant slots of the base station C differ from already allocated slots in interstation-cooperated communication.

In step S182, the base station A notifies the user terminal and the base stations B, C of the cooperated communication change response, i.e. the decision result whether to change interstation-cooperated communication. The cooperated communication change response contains various pieces of information regarding a new combination of cooperated base stations (i.e. base stations A, B, C), the MIMO mode, and allocated slots (radio resource).

In step S183, similar to step S171, the user terminal sends cooperated communication control information to the base station A.

In step S184, the base station A forwards the cooperated communication control information, received from the user terminal, to the base stations B, C.

In step S185, the base station A forwards transmitting data addressing the user terminal to the base stations B, C.

In step S186, the base stations A, B, C conduct interstation-cooperated communication with the user terminal.

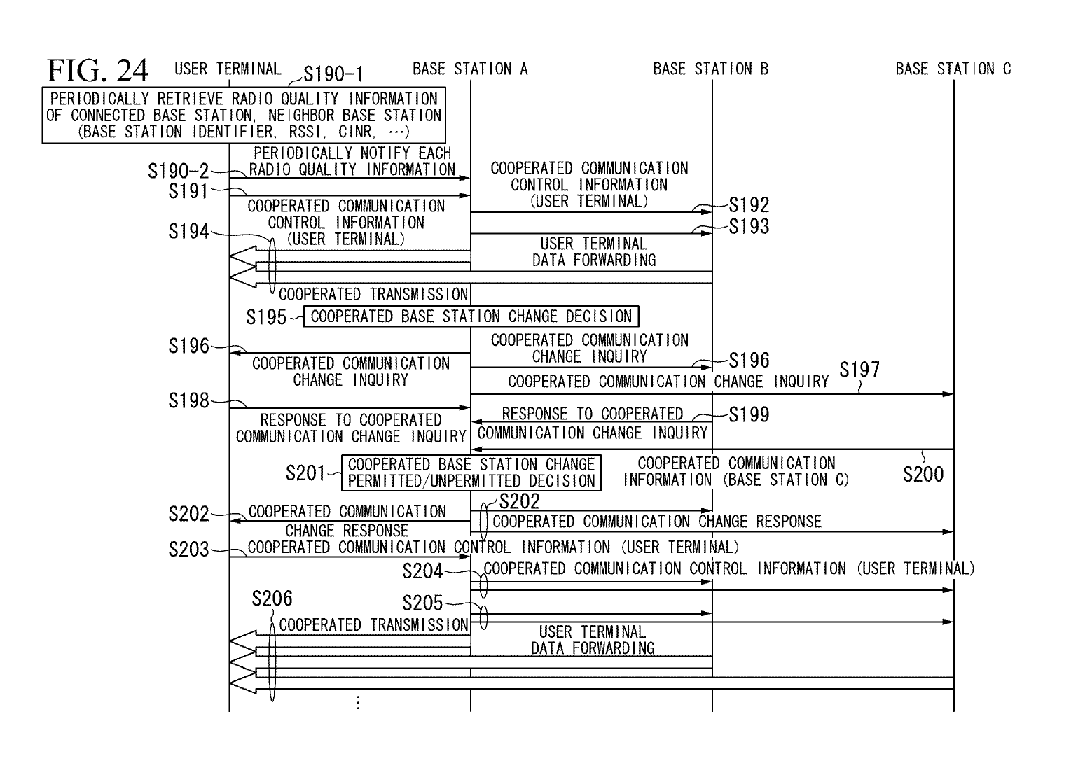

FIG. 24 is a sequence diagram showing another procedure of increasing the number of base stations conducting interstation-cooperated communication. Similar to FIG. 23, FIG. 24 shows the procedure that the user terminal, which is currently involved in interstation-cooperated communication with two base stations A, B, changes its operation to conduct interstation-cooperated communication with the increased number of cooperated base stations, i.e. three base stations A, B, C. The procedure of FIG. 24 is identical to the procedure of FIG. 23 except that the procedure of FIG. 23 causes the user terminal to request shifting of interstation-cooperated communication whilst the procedure of FIG. 24 causes the base station to request shifting of interstation-cooperated communication. Hereinafter, another procedure of increasing the number of cooperated base stations will be described with reference to FIG. 24.

In step S190-1, the user terminal periodically measures radio quality information per each base station.

In step S190-2, the user terminal periodically sends radio quality information to the base station A.

In step S191, the user terminal sends cooperated communication control information to the base station A.

In step S192, the base station A forwards the cooperated communication control information, received from the user terminal, to the base station B.

In step S193, the base station A forwards transmitting data addressing the user terminal to the base station B.

In step S194, the base stations A, B conduct interstation-cooperated communication with the user terminal.

In step S195, the base station A makes a decision, based on radio quality information, whether to change interstation-cooperated communication with two base stations A, B to interstation-cooperated communication with three base stations A, B, C. The decision criterion is identical to step S175 in FIG. 23.

In step S196, the base station A sends a cooperated communication change inquiry to the user terminal and the base station B. As the cooperated communication change inquiry, various pieces of information regarding the identifier of the user terminal, a current pair of cooperated base stations (i.e. base stations A, B), the current MIMO mode, a newly desired combination of cooperated base stations (i.e. base stations A, B, C), the MIMO mode adopted in the new combination of cooperated base stations, and currently allocated slots (radio resource) are sent to the inquired user terminal and the inquired base station.

In step S197, the base station A inquires the base station C about cooperated communication information. As the inquiry of cooperated communication information, various pieces of information regarding the MIMO mode received from the user terminal as well as the radio quality information and the processing load per each base station are sent to the inquired base station.

In step S198, the user terminal receiving the cooperated communication change inquiry makes a decision whether or not to change interstation-cooperated communication, thus responding to the base station A.

In step S199, the base station B receiving the cooperated communication change inquiry makes a decision whether or not to change interstation-cooperated communication, thus responding to the base station A.

In step S200, the base station C sends back the cooperated communication information to the base station A. The cooperated communication information contains various pieces of information regarding vacant slots available for interstation-cooperated communication, the number of user terminals, which have been already determined in accordance with interstation-cooperated communication, a pair of base stations conducting interstation-cooperated communication with user terminals, and a processing load of the currently assigned base station.

Subsequent steps S201 to S206 are identical to steps S181 to S186 in FIG. 23.

### Fourth Embodiment

The fourth embodiment exemplifies another version of the interstation-cooperated communication process after starting communication according to the first embodiment or the second embodiment (step S7). Step S7 causes the user terminal to start communicating with the base station in accordance with the communication method which is determined in the cooperated communication determination/adjustment process (step S6), wherein the fourth embodiment indicates interstation-cooperated communication as the communication method. Herein, radio resources (slots), which are determined in the cooperated communication determination/adjustment process, are continuously used (reserved); but the utilization method of radio resources is not necessarily limited to this method. The fourth embodiment indicates the situation in which a single user terminal is involved in interstation-cooperated communication, but the fourth embodiment is applicable to the other situation in which a plurality of user terminals is involved in interstation-cooperated communication. Hereinafter, a series of operations of the fourth embodiment will be described.

[Procedure of Continuing Interstation-Cooperated Communication]

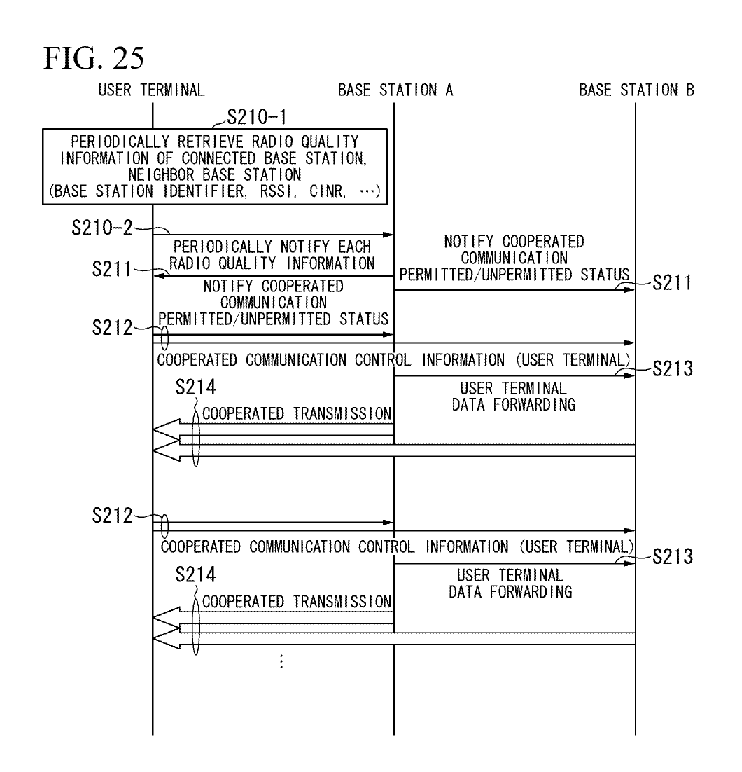

FIG. 25 is a sequence diagram showing a procedure of continuing interstation-cooperated communication. FIG. 25 shows the procedure that the user terminal, which is currently involved in interstation-cooperated communication with base stations A, B, continuously involve those interstation-cooperated communication. Hereinafter, the procedure of continuing interstation-cooperated communication will be described with reference to FIG. 25.

In step S210-1, the user terminal periodically measures radio quality information per each base station.

In step S210-2, the user terminal periodically sends radio quality information to the base station A. The transmission period is independent of the period for transmitting cooperated communication information, such as channel matrices, which is needed to continue interstation-cooperated communication.

In step S211, the base station A sends a cooperated communication permitted/unpermitted notification to the user terminal and the base station B. The cooperated communication permitted/unpermitted notification contains various pieces of information regarding a decision to conduct interstation-cooperated communication, information specifying the user terminal and the base station B conducting interstation-cooperated communication, and allocated radio resources.

In step S212, the user terminal sends cooperated communication control information to the base stations A, B. The cooperated communication control information contains radio communication information, such as channel matrices, which is needed to conduct interstation-cooperated communication.

In step S213, the base station A forwards transmitting data addressing the user terminal to the base station B. The forwarded data of the base station B conform to the MIMO mode. Specifically, when the MIMO mode indicates the transmission diversity and spatial coding, the base station A sends a copy of transmitting data, which are transmitted via interstation-cooperated communication, to the base station B. When the MIMO mode indicates the spatial multiplexing method, the base station A forwards spatially multiplied transmitting data to the base station B in order to cause the base stations A, B to transmit data independently.

The fourth embodiment refers to the direct forwarding of data from the base station A to the base station B; but the data forwarding method is not necessarily limited to this method. For instance, the base station A notifies the router 6 installed in the backbone network 4 of its decision to conduct interstation-cooperated communication, so that the router 6 copies transmitting data addressing the user terminal to perform bicasting on the base stations A, B or sends spatially multiplexed transmitting data to the base stations A, B respectively.

In step S214, the base stations A, B conduct interstation-cooperated communication with the user terminal.

Subsequently, a series of steps S212 to S214 is repeated to continue interstation-cooperated communications.

[Procedure of Decreasing the Number of Cooperated Base Stations]

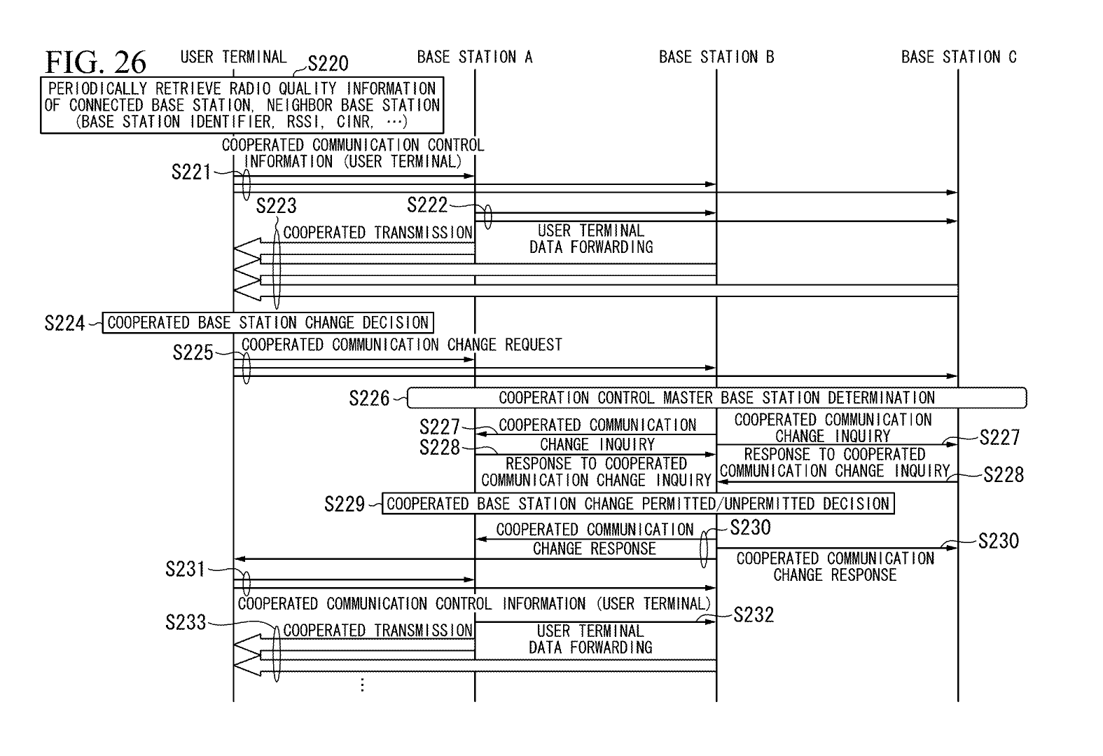

FIG. 26 is a sequence diagram showing a procedure of decreasing the number of base stations conducting interstation-cooperated communication. FIG. 26 shows that procedure that the user terminal, which is currently involved in interstation-cooperated communication with three base stations A, B, C, changes its operation to conduct interstation-cooperated communication with the decreased number of cooperated base stations, i.e. two base stations A, B. Hereinafter, the procedure of decreasing the number of cooperated base stations will be described with reference to FIG. 26.

In step S220, the user terminal periodically measures radio quality information per each base station.

In step S221, the user terminal sends cooperated communication control information to the base stations A, B, C.

In step S222, the base station A forwards transmitting data addressing the user terminal to the base stations B, C.

In step S223, the base stations A, B, C conduct interstation-cooperated communication with the user terminal.

In step S224, the user terminal makes a decision, based on radio quality information, as to whether to change interstation-cooperated communication with three base stations A, B, C to interstation-cooperated communication with two base stations A, B. The decision criterion indicates that the base station C is precluded from interstation-cooperated communication, for example, when values of RSSI and CINR of the base station C are greatly degraded compared to those of the base stations A, B. Since CINR values are calculated using carrier wave components defining signals of cooperated base stations, it is necessary to calculate CINR values per each combination of cooperated base stations.

In step S225, the user terminal sends a cooperated communication change request, indicating shifting to interstation-cooperated communication with two base stations A, B, to the base stations A, B, C. The cooperated communication change request contains various pieces of information regarding the identifier (e.g. the sequence number) specifying the cooperated communication change request, a current combination of cooperated base stations (i.e. base stations A, B, C), the current MIMO mode, a newly desired pair of cooperated base stations (i.e. base stations A, B), and the MIMO mode adopted in the new pair of cooperated base stations. The cooperated communication change request can be sent to each base station by way of the unicast or the multicast.

In step S226, the base stations A, B, C performs a process (namely, a cooperation control master base station determination process) for determining a base station acting as a main control of interstation-cooperated communication in response to the cooperated communication change request received from the user terminal. The base station acting as a main control of interstation-cooperated communication is called a “master base station”.

Next, the cooperation control master base station determination process will be described.

First, all the base stations (i.e. base stations A, B, C) receiving cooperated communication change request having the same identifier mutually exchange their master base station determining messages in accordance with information regarding a current combination of cooperated base stations. The master base station determining message contains the identifier of a cooperated communication change request, the identifier of each base station, radio quality information such as values of RSSI and CINR which the user terminal transmitting the cooperated communication change request measures per each base station, a processing load of each base station, and a list of other base stations involved in processing of the cooperated communication change request.

Next, the base stations A, B, C independently make a decision as to whether or not each base station serves as a master base station in accordance with information included in the master base station determining message and the cooperated communication change request as well as their common decision criteria. As decision criteria, for example, it is possible to name criteria (1), (2), (3) as follows:

(1) The base station having the highest base station identifier (or a base station having the lowest base station identifier).
(2) The base station having the lowest processing load.
(3) The base station having the best radio environment with the user terminal which is a source of transmitting the cooperated communication change request.

As the method for selecting candidates of master base stations, it is possible to name methods (1), (2), (3) as follows:

(1) All the base stations specified by specific pieces of information included in the cooperated communication change request (i.e. a current pair of cooperated base stations, and a newly desired pair of cooperated base stations).
(2) The base stations which prefer to continuously conducting interstation-cooperated communication.
(3) The base stations which can be precluded from base stations conducting interstation-cooperated communication.

It is possible to select the base station assigned to the user terminal as the master base station; in this case, the cooperation control master base station determination process is not needed.

Now, the description refers back to FIG. 26.

Herein, the cooperation control master base station determination process determines the base station B as the master base station.

In step S227, the base station B sends a cooperated communication change inquiry to the base stations A, C.

As the cooperated communication change inquiry, various pieces of information regarding the identifier of the cooperated communication change request, the identifier of the user terminal, information included in the cooperated communication change request, and currently allocated slots (radio resource) are sent to the inquired base stations.

In step S228, the base stations A, C receiving the cooperated communication change inquiry makes a decision whether or not to change interstation-cooperated communication, thus responding to the base station B.

In step S229, the base station B makes a decision whether or not to change interstation-cooperated communication based on the status of the base station B and the responses to the cooperated communication change inquiry from the base stations A, C.

In step S230, the base station B notifies the user terminal and the base stations A, C of the cooperated communication change response, i.e. the decision result whether or not to change interstation-cooperated communication. The cooperated communication change response contains various pieces of information regarding the identifier of the cooperated communication change request, a new pair of cooperated base stations (i.e. base stations A, B), the MIMO mode, and allocated slots (radio resource regions).

In step S231, the user terminal sends cooperated communication control information to the base stations A, B.

In step S232, the base station A forwards transmitting data addressing the user terminal to the base station B.

In step S233, the base stations A, B conduct interstation-cooperated communication with the user terminal.

In the procedure of decreasing the number of cooperated base stations shown in FIG. 26, the base station B acts as the master base station but the user terminal is continuously assigned to the base station A; hence, transmitting data addressing the user terminal are forwarded from the base station A to the base station B.

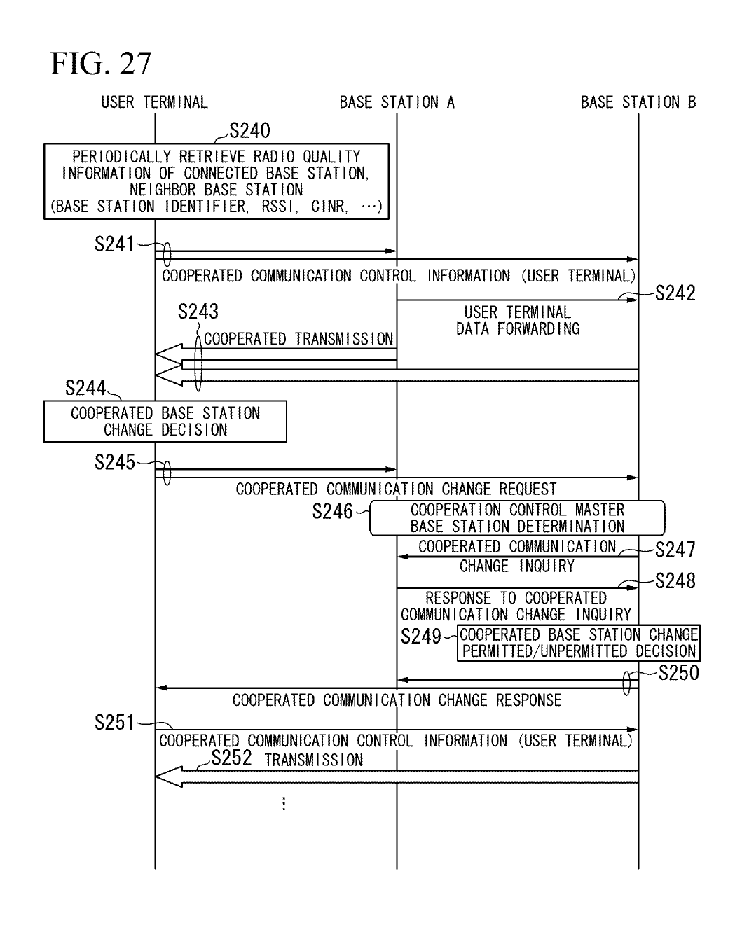

FIG. 27 is a sequence diagram showing another procedure of decreasing the number of base stations conducting interstation-cooperated communication. FIG. 27 shows the procedure that the user terminal, which is currently involved in interstation-cooperated communication with two base stations A, B, changes it operation to establish a single-site connection with the base station B due to movement.

Hereinafter, another procedure of decreasing the number of cooperated base stations will be described with reference to FIG. 27.

In step S240, the user terminal periodically measures radio quality information per each base station.

In step S241, the user terminal sends cooperated communication control information to the base stations A, B.

In step S242, the base station A forwards transmitting data addressing the user terminal to the base station B.

In step S243, the base stations A, B conduct interstation-cooperated communication with the user terminal.

In step S244, the user terminal makes a decision whether to change its operation from interstation-cooperated communication with two base stations A, B to a single-site connection with the base station B based on radio quality information. As the decision criterion, the user terminal changes its operation to a single-site connection with the base station B, for example, when values of RSSI and CINR of the base station A are greatly degraded compared to those of the base station B. Since CINR values are calculated using carrier wave components defining signals of cooperated base stations, it is necessary to calculate CINR values per each combination of cooperated base stations.

In step S245, the user terminal sends a cooperated communication change request, indicating its decision to establish a single-site connection with the base station B, to the base stations A, B. The cooperated communication change request contains various pieces of information regarding the identifier specifying the cooperated communication change request (e.g. the sequence number), a current pair of cooperated base stations (i.e. base stations A, B), the currently adopted MIMO mode, a newly desired connected base station (i.e. the base station B), and the MIMO mode adopted in the newly connected base station. In this connection, the cooperated communication change request can be sent to each base station by way of unicast or multicast.

In step S246, similar to step S226 in FIG. 26, the base stations A, B perform the cooperation control master base station determination process in response to the cooperated communication change request received from the user terminal. Herein, the base station B is selected as the master base station.

In step S247, the base station B sends a cooperated communication change inquiry to the base station A. As the cooperated communication change inquiry, various pieces of information regarding the identifier of the cooperated communication change request, the identifier of the user terminal, information included in the cooperated communication change request, and currently allocated slots (radio resource regions) are sent to the inquired base stations.

In step S248, the base station A receiving the cooperated communication change inquiry makes a decision whether or not to change interstation-cooperated communication, thus responding to the base station B.

In step S249, the base station B makes a decision whether or not to change interstation-cooperated communication based on the status of the base station B and the response to the cooperated communication change inquiry from the base station A.

In step S250, the base station B notifies the user terminal and the base station A of the cooperated communication change response, i.e. the decision result whether or not to change interstation-cooperated communication. The cooperated communication change response contains various pieces of information regarding the identifier of the cooperated communication change request, the newly connected base station (i.e. the base station B), the MIMO mode, and allocated slots (radio resource regions).

In step S251, the user terminal sends cooperated communication control information to the base station B establishing a single-site connection therewith.

In step S252, the base station B communicates with the user terminal via a single-site connection.

Subsequently, steps S251 and S252 are repeated.

The procedure of decreasing the number of cooperated base stations shown in FIG. 27 causes a handover of the assigned base station of the user terminal, which is changed from the base station A to the base station B; hence, a procedure of changing the assigned base station of the user terminal is performed in the backbone network. Therefore, the user terminal belongs to the base station B after changing its operation to a single-site connection; hence, transmitting data addressing the user terminal is directly transmitted from the base station B to the user terminal without passing by the base station A.

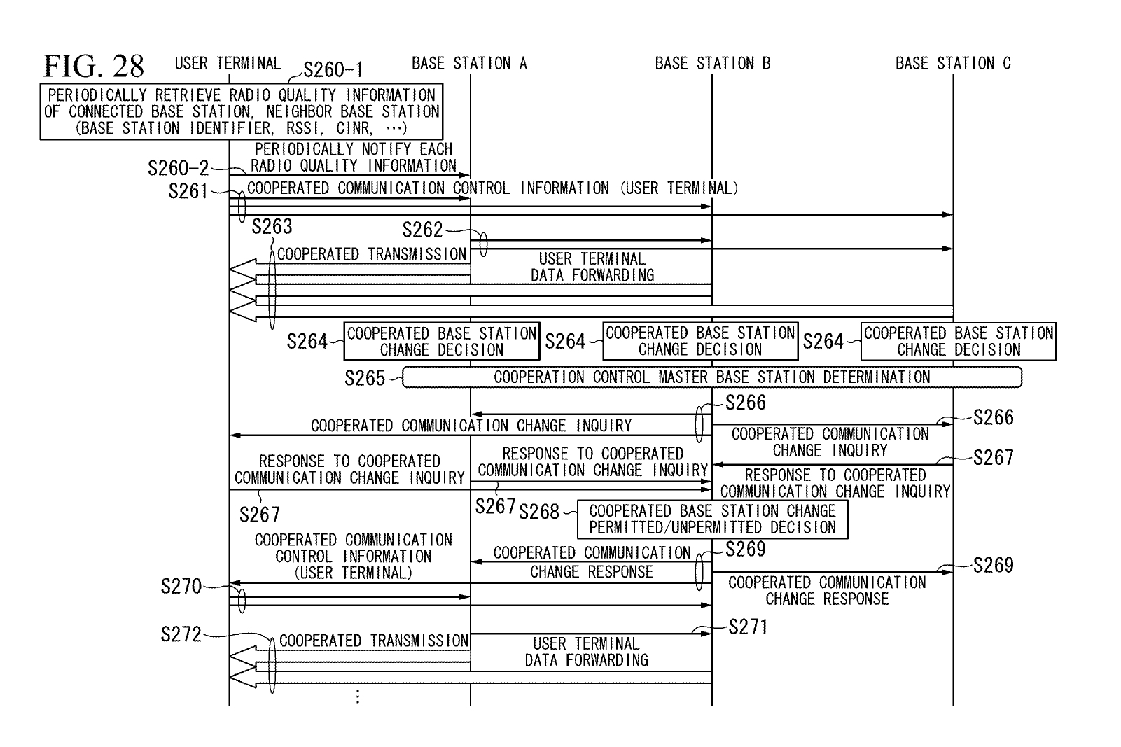

FIG. 28 is a sequence diagram showing a further procedure of decreasing the number of base stations conducting interstation-cooperated communication. Similar to FIG. 26, FIG. 28 shows the procedure that the user terminal, which is currently involved in interstation-cooperated communication with three base stations, changes its operation to conduct interstation-cooperated communication with the decreased number of cooperated base stations, i.e. two base stations A, B. The procedure of FIG. 28 is identical to the procedure of FIG. 26 except that the procedure of FIG. 26 causes the user terminal to request shifting of interstation-cooperated communication whilst the procedure of FIG. 28 causes the base station to request shifting of interstation-cooperated communication. Hereinafter, the procedure of decreasing the number of cooperated base stations will be described with reference to FIG. 28.

In step S260-1, the user terminal periodically measures radio quality information per each base station.

In step S260-2, the user terminal periodically sends radio quality information to the base station A.

In step S261, the user terminal sends cooperated communication control information to the base stations A, B, C.

In step S262, the base station A forwards transmitting data addressing the user terminal to the base stations B, C.

In step S263, the base stations A, B, C conduct interstation-cooperated communication with the user terminal.

In step S264, the base stations A, B, C make a decision as to whether or not interstation-cooperated communication with three base stations A, B, C are changed to interstation-cooperated communication with two base stations A, B based on radio quality information. The decision criterion is identical to step S224 in FIG. 26. At least one of the base stations A, B, C is required to present a decision that interstation-cooperated communication be changed to interstation-cooperated communication with two base stations A, B.

In step S265, the base stations A, B, C perform the cooperation control master base station determination process.

Next, the cooperation control master base station determination process will be described.

First, the base station, which presents a decision that interstation-cooperated communication be changed to interstation-cooperated communication with two base stations A, B, instruct the currently cooperated base stations (i.e. base stations A, B, C) to mutually exchange their master base station determining messages, thus implementing an exchange of master base station determining messages. The master base station determining message contains various pieces of information regarding the identifier of the user terminal involved in interstation-cooperated communication, the identifier of each base station, radio quality information such as values of RSSI and CINR measured by the user terminal involved in interstation-cooperated communication per each base station, a processing load of each base station, and a list of other base stations involved in processing of controlling interstation-cooperated communication.

Next, the base stations A, B, C independently make a decision as to whether or not each base station serves as a master base station based on information included in master base station determining messages and their common decision criteria. The decision criteria are identical to the foregoing ones.

Now, the description refers back to FIG. 28.

Herein, the cooperation control master base station determination process determines the base station B as the master base station.

In step S266, the base station B sends a cooperated communication change inquiry to the user terminal and the base stations A, C. As the cooperated communication change inquiry, various pieces of information regarding the identifier of the user terminal, the current combination of cooperated base stations (i.e. base stations A, B, C), the currently adopted MIMO mode, a newly desired pair of cooperated base stations (i.e. base stations A, B), the MIMO mode adopted in the new pair of cooperated base stations, and currently allocated slots (radio resource) are sent to the inquired user terminal and the inquired base stations.

In step S267, the user terminal and the base stations A, C, all receiving the cooperated communication change inquiry, makes a decision whether to change interstation-cooperated communication, thus responding to the base station B.

In step S268, the base station B makes a decision whether to change interstation-cooperated communication based on the status of the base station B and the responses to the cooperated communication change inquiry from the user terminal and the base stations A, C.

Subsequent steps S269 to S272 are identical to steps S230 to S233 in FIG. 26.

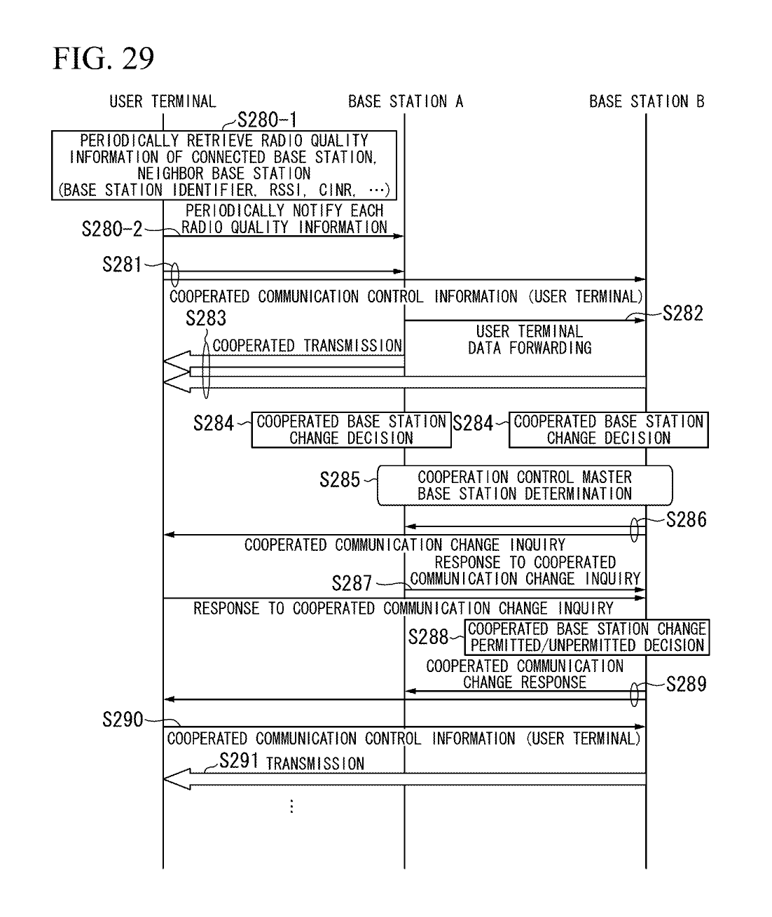

FIG. 29 is a sequence diagram showing another procedure of decreasing the number of base stations conducting interstation-cooperated communication. FIG. 29 shows the procedure that the user terminal, which is currently involved in interstation-cooperated communication with two base stations A, B, changes its operation to establish a single-site connection with the base station B due to movement. Hereinafter, another procedure of decreasing the number of cooperated base stations will be described with reference to FIG. 29.

In step S280-1, the user terminal periodically measures radio quality information per each base station.

In step S280-2, the user terminal periodically sends radio quality information to the base station A.

In step S281, the user terminal sends cooperated communication control information to the base stations A, B.

In step S282, the base station A forwards transmitting data addressing the user terminal to the base station B.

In step S283, the base stations A, B conduct interstation-cooperated communication with the user terminal.

In step S284, the base stations A, B makes a decision whether to change its operation from interstation-cooperated communication with two base stations to a single-site connection with the base station B. The decision criterion is identical to step S244 in FIG. 27. In this connection, at least one of the base stations A, B is required to make a decision whether to change its operation to a single-site connection with the base station B.

In step S285, similar to step S265 in FIG. 28, the base stations A, B performs the cooperation control master base station determination process. Herein, the base station B is selected as the master base station.

In step S286, the base station B sends a cooperated communication change inquiry, indicating shifting to a single-site connection with the base station B, to the user terminal and the base station A. As the cooperated communication change inquiry, various pieces of information regarding the identifier of the user terminal, the current pair of cooperated base stations (i.e. base stations A, B), the currently adopted MIMO mode, a newly desired connected base station (i.e. the base station B), the MIMO mode adopted in the newly connected base station, and currently allocated slots (radio resource regions) are sent to the inquired user terminal and the inquired base station.

In step S287, the user terminal and the base station A, both receiving the cooperated communication change inquiry, makes a decision whether to change interstation-cooperated communication, thus responding to the base station B.

In step S288, the base station B makes a decision whether or not to change interstation-cooperated communication based on the status of the base station B and the responses to the cooperated communication change inquiry from the user terminal and the base station A.

Subsequent steps S289 to S291 are identical to steps S250 to S252 in FIG. 27.

The procedure of decreasing the number of cooperated base stations in FIG. 29 causes a handover of the base station assigned to the user terminal from the base station A to the base station B, so that the procedure of changing the assigned base station of the user terminal is implemented in the backbone network. Therefore, after shifting to a single-site connection, the user terminal belongs to the base station B, so that transmitting data addressing the user terminal are directly transmitted from the base station B to the user terminal without passing by the base station A.

[Procedure of Increasing the Number of Cooperated Base Stations]

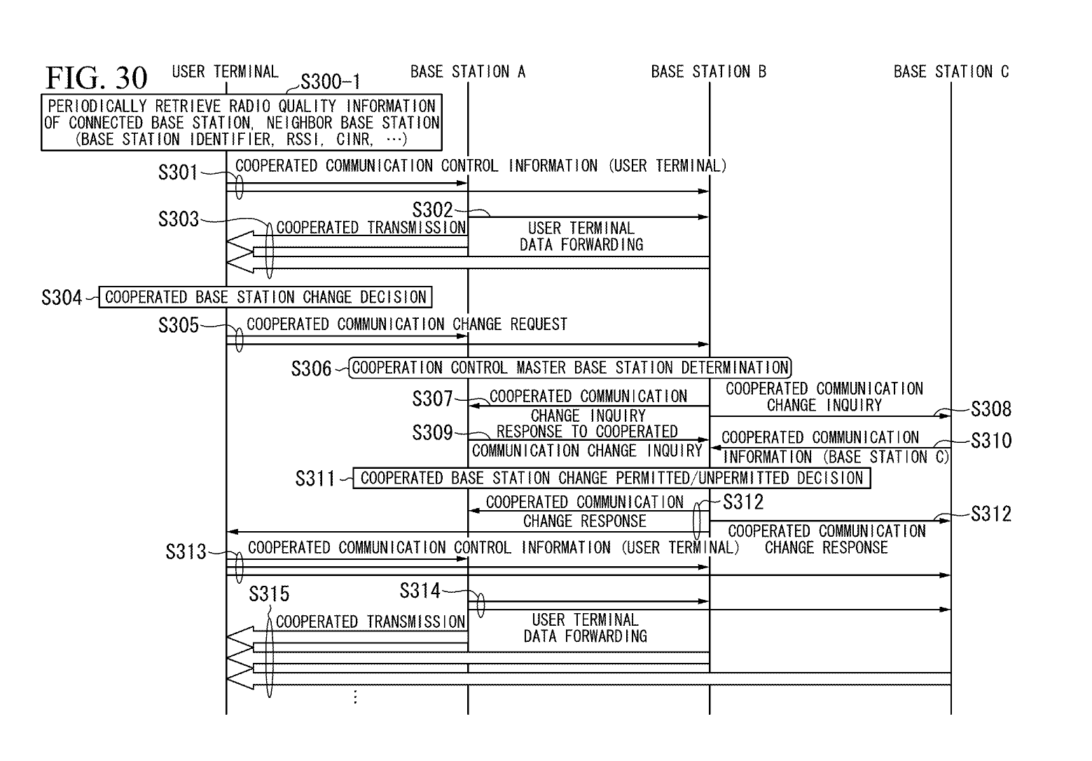

FIG. 30 is a sequence diagram showing a procedure of increasing the number of base stations conducting interstation-cooperated communication. FIG. 30 shows the procedure that the user terminal, which is currently involved in interstation-cooperated communication with two base stations A, B, changes its operation to conduct interstation-cooperated communication with the increased number of cooperated base stations, i.e. three base stations A, B, C. Hereinafter, the procedure of increasing the number of cooperated base stations will be described with reference to FIG. 30.

In step S300, the user terminal periodically measures radio quality information per each base station.

In step S301, the user terminal sends cooperated communication control information to the base stations A, B.

In step S302, the base station forwards transmitting data addressing the user terminal to the base station B.

In step S303, the base stations A, B conduct interstation-cooperated communication with the user terminal.

In step S304, the user terminal makes a decision whether to change its operation from interstation-cooperated communication with two base stations A, B to interstation-cooperated communication with three base stations A, B, C based on radio quality information. As the decision criterion, for example, the user terminal decides to add the base station C to interstation-cooperated communication when values of RSSI and CINR of the base station C are improved and become comparable to those of the base stations A, B. Since CINR values are calculated using carrier wave components defining signals of cooperated base stations, it is necessary to calculate CINR values per each combination of cooperated base stations.

In step S305, the user terminal sends a cooperated communication change request, indicating shifting to interstation-cooperated communication with three base stations A, B, C, to the base stations A, B. The cooperated communication change request contains the identifier of the cooperated communication change request, the current pair of cooperated base stations (i.e. base stations A, B), the currently adopted MIMO mode, a newly desired combination of cooperated base stations (i.e. base stations A, B, C), and the MIMO mode adopted in the new combination of cooperated base stations.

In step S306, similar to step S226 in FIG. 26, the base stations A, B performs the cooperation control master base station determination process in response to the cooperated communication change request received from the user terminal. Herein, the base station B is selected as the master base station.

In step S307, the base station B sends a cooperated communication change inquiry to the base station A. As the cooperated communication change inquiry, various pieces of information regarding the identifier of the cooperated communication change request, the identifier of the user terminal, information included in the cooperated communication change request, and currently allocated slots (radio resource) are sent to the inquired base station.

In step S308, the base station B inquires the base station C about cooperated communication information. As the inquiry of cooperated communication information, various pieces of information regarding the identifier of the cooperated communication change request as well as the MIMO mode, radio quality information per each base station and processing loads, all received from the user terminal, are sent to the inquired base station.

In step S309, the base station A receiving the inquiry of cooperated communication information makes a decision whether to change interstation-cooperated communication, thus responding to the base station B.

In step S310, the base station C sends back cooperated communication information to the base station B. The cooperated communication information contains various pieces of information regarding the identifier of the cooperated communication change request, vacant slots available to interstation-cooperated communication, the number of user terminals which are determined in advance in accordance with interstation-cooperated communication, a pair of base stations conducting interstation-cooperated communication with the user terminal, and a processing load to the currently assigned base station.

In step S311, the base station B makes a decision whether or not to change interstation-cooperated communication based on the status of the base station B, the response to the cooperated communication change inquiry from the base station A, and the cooperated communication information from the base station C. During allocation of radio resources, it is possible to adjust available slots when vacant slots of the base station C differ from slots which are currently used in interstation-cooperated communication.

In step S312, the base station B notifies the user terminal and the base stations A, C of the cooperated communication change response, i.e. the decision result whether or not to change interstation-cooperated communication. The cooperated communication change response contains various pieces of information regarding the identifier of the cooperated communication change request, a new combination of cooperated base stations (i.e. base stations A, B, C), the MIMO mode, and allocated slots (radio resource).

In step S313, the user terminal sends cooperated communication control information to the base stations A, B, C.

In step S314, the base station A forwards transmitting data addressing the user terminal to the base stations B, C.

In step S315, the base stations A, B, C conduct interstation-cooperated communication with the user terminal.

In the procedure of increasing the number of cooperated base stations in FIG. 30, the base station A still remains as the assigned base station of the user terminal though the base station B acts as the master base station. For this reason, transmitting data addressing the user terminal are transmitted from the base station A to the base stations B, C.

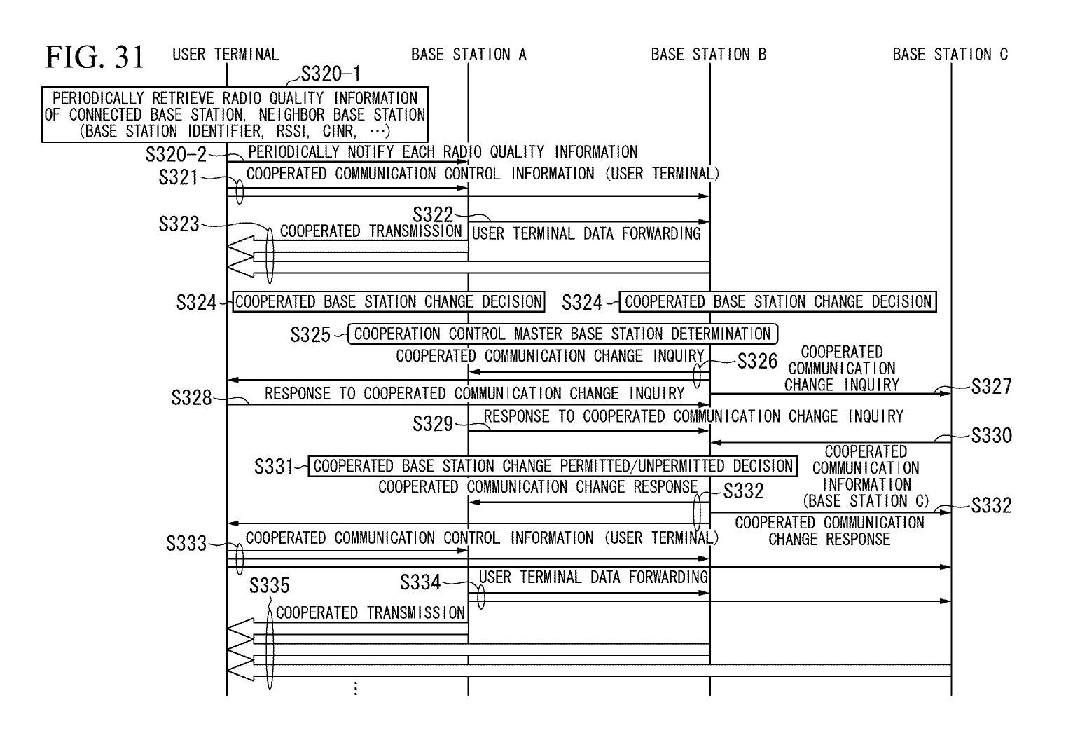

FIG. 31 is a sequence diagram showing another procedure of increasing the number of base stations conducting interstation-cooperated communication. Similar to FIG. 30, FIG. 31 shows the procedure that the user terminal, which is currently involved in interstation-cooperated communication with two base stations A, B, changes its operation to conduct interstation-cooperated communication with the increased number of cooperated base stations, i.e. three base stations A, B, C. The procedure of FIG. 31 is identical to the procedure of FIG. 30 except that the procedure of FIG. 30 causes the user terminal to request shifting of interstation-cooperated communication whilst the procedure of FIG. 31 causes the base station to request shifting of interstation-cooperated communication. Hereinafter, another procedure of increasing the number of cooperated base stations will be described with reference to FIG. 31.

In step S320-1, the user terminal periodically measures radio quality information per each base station.

In step S320-2, the user terminal periodically sends radio quality information to the base station A.

In step S321, the user terminal sends cooperated communication control information to the base stations A, B.

In step S322, the base station A forwards transmitting data addressing the user terminal to the base station B.

In step S323, the base stations A, B conduct interstation-cooperated communication with the user terminal.

In step S324, the base stations A, B make a decision whether to change interstation-cooperated communication with two base stations A, B to interstation-cooperated communication with three base stations A, B, C. The decision criterion is identical to step S304 in FIG. 30. In this connection, at least one of the base stations A, B is required to make a decision on shifting to interstation-cooperated communication with three base stations A, B, C.

In step S235, similar to step S265 in FIG. 28, the base stations A, B performs the cooperation control master base station determination process. Herein, the base station B is selected as the master base station.

In step S236, the base station B sends a cooperated communication change inquiry to the user terminal and the base station A. As the cooperated communication change inquiry, various pieces of information regarding the identifier of the user terminal, the current pair of cooperated base stations (i.e. base stations A, B), the currently adopted MIMO mode, a newly desired combination of cooperated base stations (i.e. base stations A, B, C), the MIMO mode adopted in the new combination of cooperated base stations, and currently allocated slots (radio resource regions) are send to the inquired user terminal and the inquired base station.

In step S237, the base station B inquires the base station C about cooperated communication information. As the inquiry of cooperated communication information, various pieces of information received from the user terminal, such as the MIMO mode, radio quality information per each base station, and processing loads, are sent to the inquired base station.

In step S328, the user terminal receiving the cooperated communication change inquiry makes a decision whether to change interstation-cooperated communication, thus responding to the base station B.

In step S329, the base station A receiving the cooperated communication change inquiry makes a decision whether to change interstation-cooperated communication, thus responding to the base station B.

In step S330, the base station C sends cooperated communication information to the base station B. The cooperated communication information contains various pieces of information regarding vacant slots available in interstation-cooperated communication, the number of user terminals which are determined in advance in accordance with interstation-cooperated communication, a pair of base stations conducting interstation-cooperated communication with user terminals, and the processing load of the currently assigned base station.

Subsequent steps S332 to S335 are identical to steps S312 to S315 in FIG. 30.

### Fifth Embodiment

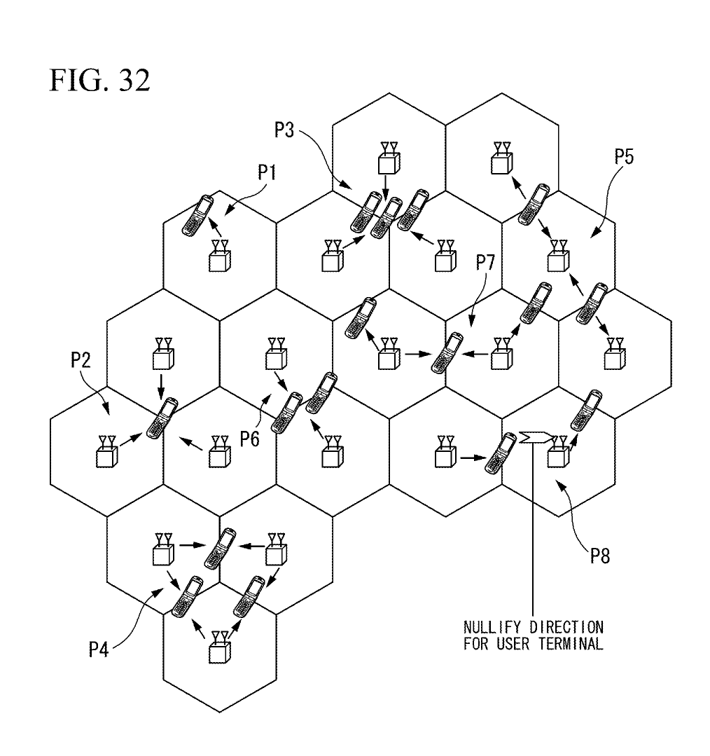

FIG. 32 shows an example of the cooperated situation of interstation-cooperated communication in the cellular mobile communication system according to a fifth embodiment. In the cellular mobile communication system of the fifth embodiment, the cooperated base stations conducting interstation-cooperated communication determine cooperation methods suited to the status of interstation-cooperated communication and the status of the user terminal involved in interstation-cooperated communication. This enables interstation-cooperated communication to be conducted using various cooperation methods entirely in the cellular mobile communication system. Hereinafter, various examples of cooperated situations of interstation-cooperated communication will be described with reference to FIG. 32.

[Cooperated Situation P1]

The cooperated situation P1 refers to a single-site connection. At this time, the user terminal establishes a single-site connection with the base station in accordance with the transmission diversity and spatial coding or the spatial multiplexing method.

[Cooperated Situation P2]

The cooperated situation P2 refers to the connected situation in which three base stations conduct interstation-cooperated communication with a single user terminal. This operation is adopted when a plurality of user terminals cannot be spatially multiplexed using the MU-MIMO technology.

[Cooperated Situation P3]

The cooperated situation P3 refers to the connected situation in which a plurality of user terminals is spatially multiplexed using the MU-MINO technology, and each user terminal is involved in interstation-cooperated communication with three base stations. The cooperated situation P3 is adopted when three user terminals are able to mutually communicate with three base stations. In the cooperated situation P3, three user terminals and three base stations perform 6×6 MIMO communication in total.

[Cooperated Situation P4]

The cooperated situation P4 refers to the connected situation in which a plurality of user terminals is spatially multiplexed using the MU-MIMO technology, and each user terminal is involved in interstation-cooperated communication with three base stations. The cooperated situation P4 differs from the cooperated situation P3 in that each user terminal receives/transmits data with two base stations. At this time, three user terminals and three base stations perform 6×6 MIMO communication according to the MU-MIMO technology. In this sense, however, MIMO communication are subjected to pre-coding (pre-processing) so that they are not interfered with other base stations which do not perform transmission/reception of data.

[Cooperated Situation P5]

The cooperated situation P5 refers to the connected situation in which a plurality of user terminals is spatially multiplexed using the MU-MIMO technology, and each user terminal is involved in interstation-cooperated communication with three base stations. The cooperated situation P5 is basically the same connected situation as the cooperated situation P4, whereas it is characterized in that the cooperated base stations are linearly aligned. For this reason, the cooperated situation P5 cannot achieve interstation-cooperated communication using outermost base stations disposed at the opposite ends of the linear alignment of base stations.

[Cooperated Situation P6]

The cooperated situation P6 refers to interstation-cooperated communication using two base stations. In the cooperated situation P6, two user terminals are spatially multiplexed using the MU-MIMO technology so that data communication is performed on each user terminal at the same timing.

[Cooperated Situation P7]

The cooperated situation P7 refers to interstation-cooperated communication with two base stations. In the cooperated situation P7, three user terminals are spatially multiplexed using the MU-MIMO technology. Among user terminals conducting simultaneous communication using the MU-MIMO technology, each of two user terminals, which are not located in the overlapped area between the cells of two base stations, performs communication using a single base station and a single antenna.

[Cooperated Situation P8]

The cooperated situation P8 refers to interstation-cooperated communication with two base stations. In the cooperated situation P8, a multi-site connection is not established with respect to user terminals located in the overlapped area between the cells of two base stations, but a single-site connection is established with one base station. At this time, the other base station reduces its transmission power in communication via a single-site connection with the user terminal located close thereto. Alternatively, the other base station uses the beam forming technology to direct the antenna pattern in the nullified direction for the user terminal located in the overlapped area between the cells of two base stations, thus communicating with another user terminal, which is able to establish a single-site connection therewith, by use of the antenna pattern.

The foregoing embodiments of the present invention are described with reference to the drawings; however, the specific configurations are not necessarily limited to the foregoing embodiments; hence, this invention embraces design changes not departing from essential matters of this invention.

According to the foregoing embodiments of this invention, the base station cooperating unit is installed in each base station; the base station cooperating units mutually communicate with each other via the backbone network; the base station cooperating units of the base stations conducting interstation-cooperated communication cooperate with each other to control interstation-cooperated communication. Thus, it is possible to achieve interstation-cooperated communication entirely in the cellular mobile communication system. As a result, interstation-cooperated communication can be conducted in the any boundary between the adjacent cells; this contributes to the realization of the uniform communication service provided in the cellular mobile communication system.

Additionally, the base station cooperating unit retrieves information regarding the radio quality status of each base station conducting interstation-cooperated communication with a specific user terminal; the base station cooperating unit makes a decision whether or not to allow for interstation-cooperated communication with each base station based on this information; thereafter, the base station cooperating unit determines the communication method suited to the user terminal based on the decision result. Thus, it is possible to perform interstation-cooperated communication in response to the radio communication status.

### DESCRIPTION OF THE REFERENCE NUMERALS

1 . . . base station; 2 . . . mobile station (user terminal); 3, 3A, 3B . . . cell; 4 . . . backbone network; 5 . . . core network; 6 . . . router; 10 . . . base station cooperating unit (base station control device); 11, 21 . . . radio unit; 12, 22 . . . user data/control message processing unit; 13, 23 . . . high layer unit; 14, 24 . . . processing load measuring unit; 15 . . . terminal information storing unit; 20 . . . cooperation processing unit; 25 . . . radio environment cognition unit.

1. A cellular mobile communication system in which a plurality of base stations communicates with mobile stations, each base station being included in said cellular mobile communication system comprising:
a retrieval unit that retrieves information regarding radio communication status of each base station communicating with a predetermined mobile station;
a decision unit that makes a decision whether or not to permit interstation-cooperated communication with each base station based on the information; and
a determination unit that determines a communication method adopted in the mobile station base on a decision result.

2. The cellular mobile communication system according to claim 1, further comprising a survey unit that surveys a mobile station which is able to perform spatial multiplexing with the mobile station conducting interstation-cooperated communication.

3. The cellular mobile communication system according to claim 1, wherein the decision unit makes a decision whether or not a multi-site connection can be established with a candidate of a base station preferred by the mobile station, and
wherein when the decision unit determines that the multi-site connection cannot be established with the candidate of the base station preferred by the mobile station, the determination unit selects a single-site connection as the communication method adopted in the mobile station.

4. The cellular mobile communication system according to claim 3, wherein each base station further includes a notification unit that notifies another candidate of a base station, other than the base station establishing the single-site connection, of a message that the mobile station communicates with the base station via the single-site connection, and
wherein the base station, selected as the candidate of the base station, includes a suppression unit that suppresses interference occurring in the mobile station establishing the single-site connection.

5. The cellular mobile communication system according to claim 4, wherein the base station, selected as the candidate of the base station, establishes a single-site connection with another mobile station in a radio resource slot which allows the mobile station establishing the single-site connection to perform communication whilst the suppression unit reduces transmission power to suppress interference occurring in the mobile station establishing the single-site connection.

6. The cellular mobile communication system according to claim 4, wherein the base station, selected as the candidate of the base station, performs beam forming to nullify a direction for the mobile station establishing the single-site connection, wherein the base station further includes a communication unit that communicates with another mobile station by way of beam shaping.

7. The cellular mobile communication system according to claim 1, wherein the mobile station includes a transmitter unit that transmits cooperated communication control information, which is necessary to conduct interstation-cooperated communication, to the base station assigned to the mobile station alone, wherein each base station further includes a forwarding unit that forwards the cooperated communication control information, received from the mobile station belonging thereto, to the base station conducting interstation-cooperated communication with the mobile station, and an inquiry unit that sends an inquiry to the base station conducting interstation-cooperated communication about an operation of changing the communication method, and
wherein the decision unit makes a decision whether or not to change the communication method based on a response to the inquiry.

8. The cellular mobile communication system according to claim 1, wherein the mobile station further includes a transmitter unit that transmits cooperated communication control information, which is necessary to conduct interstation-cooperated communication, to all the base stations involved in interstation-cooperated communication,
wherein the determination unit determines a master base station conducting a main control on interstation-cooperated communication among the base stations involved in interstation-cooperated communication with the base station thereof, and
wherein each base station, which is currently selected as the master base station, further includes an inquiry unit that sends an inquiry to the other base station involved in interstation-cooperated communication about an operation of changing the communication method, so that the decision unit makes a decision whether or not to change the communication method based on a response to the inquiry.

9. The cellular mobile communication system according to claim 1, wherein the mobile station further includes a request unit that requests the base station to start or change interstation-cooperated communication.

10. The cellular mobile communication system according to claim 1, wherein each base station further includes a request unit that requests the mobile station and the base station to start or change interstation-cooperated communication.

11. A base station control device installed in a base station communicating with a mobile station, said base station control device comprising:
a retrieval unit that retrieves information regarding radio communication status of the base station involved in interstation-cooperated communication with a predetermined base station;
a decision unit that makes a decision whether or not to permit interstation-cooperated communication with the base station based on the information; and
a determination unit that determines a communication method adopted in the mobile station based on a decision result.

12. The base station control device according to claim 11, further comprising a survey unit that surveys a mobile station which is able to perform spatial multiplexing with the mobile station involved in interstation-cooperated communication.

13. The base station control device according to claim 11, wherein the decision unit makes a decision as to whether or not a multi-site connection can be established with a candidate of a base station preferred by the mobile station, and
wherein when the decision unit determines that the multi-site connection cannot be established with the candidate of the base station preferred by the mobile station, the determination unit selects a single-site connection as the communication method adopted in the mobile station.

14. The base station control device according to claim 13, wherein the base station includes a notification unit that notifies another candidate of a base station, other than the base station establishing the single-site connection, of a message that the mobile station communicates with the base station via the single-site connection, so that the base station, selected as the candidate of the base station, suppresses interference occurring in the mobile station establishing the single-site connection.

15. The base station control device according to claim 11, wherein each base station further includes a forwarding unit that forwards cooperated communication information, received from the mobile station belonging thereto, to the base station conducting interstation-cooperated communication with the mobile station, and an inquiry unit that sends an inquiry to the base station conducting interstation-cooperated communication about an operation of changing the communication method, and
wherein the decision unit makes a decision whether or not to change the communication method based on a response to the inquiry.

16. The base station control device according to claim 11, wherein the determination unit determines a master base station conducting a main control on interstation-cooperated communication among all the base stations involved in interstation-cooperated communication with the base station thereof, and
wherein the base station, which is selected as the master base station, includes an inquiry unit that sends an inquiry to all the base stations involved in interstation-cooperated communication about an operation of changing the communication method, so that the decision unit makes a decision whether or not to change the communication method based on a response to the inquiry.

17. The base station control device according to claim 11, further comprising a request unit that requests the mobile station and the base station to start or change interstation-cooperated communication.

18. An interstation-cooperated communication control method on communication conducted by mobile stations with a plurality of base stations, said interstation-cooperated communication control method comprising the steps of:
retrieving information regarding a radio communication status of the base station conducting interstation-cooperated communication with a predetermined mobile station;
making a decision whether or not to permit interstation-cooperated communication with the base station based on the information by means of a base station cooperating unit; and
determining a communication method adopted in the mobile station based on a decision result.

19. The interstation-cooperated communication control method according to claim 18, further comprising the step of:
surveying a mobile station which is able to perform spatial multiplexing with the mobile station conducting interstation-cooperated communication.

20. The interstation-cooperated communication control method according to claim 18, further comprising the step of:
when it is determined that a multi-site connection cannot be established with a candidate of a base station preferred by the mobile station, selecting a single-site connection as the communication method adopted in the mobile station.

21. The interstation-cooperated communication control method according to claim 20, further comprising the step of:
notifying another candidate of a base station, other than the base station establishing the single-site connection, of a message that the mobile station communicates with the base station via the single-site connection while suppressing interference occurring in the mobile station establishing the single-site connection.

22. The interstation-cooperated communication control method according to claim 21, further comprising the step of:
establishing a single-site connection with another base station in a radio resource slot that allows the mobile station to perform communication via the single-site connection while reducing transmission power to suppress interference occurring in the mobile station establishing the single-site connection.

23. The interstation-cooperated communication control method according to claim 21, further comprising the step of:
performing beam forming to nullify a direction for the mobile station establishing the single-site connection while communicating with another mobile station by way of beam shaping.

24. The interstation-cooperated communication control method according to claim 18, further comprising the steps of:
transmitting, by the mobile station, cooperated communication control information, which is necessary for the mobile station to conduct interstation-cooperated communication, to the base station assigned to the mobile station alone;
forwarding the cooperated communication control information, received from the mobile station assigned to the base station, to another base station involved in interstation-cooperated communication with the mobile station;
sending an inquiry to all the base stations conducting interstation-cooperated communication about an operation of changing the communication method; and
making a decision whether or not to change the communication method based on a response to the inquiry.

25. The interstation-cooperated communication control method according to claim 18, further comprising the steps of:
transmitting, by the mobile station, cooperated communication control information, which is necessary for the mobile station to conduct interstation-cooperated communication, to all the base stations involved in interstation-cooperated communication;
determining a master base station conducting a main control on interstation-cooperated communication among all the base stations involved in interstation-cooperated communication;
sending an inquiry from the base station, which is currently selected as the master base station, to another base station involved in interstation-cooperated communication about an operation of changing the communication method; and
making a decision whether or not to change the communication method based on a response to the inquiry.

26. The interstation-cooperated communication control method according to claim 18, further comprising the step of:
requesting, by the mobile station, the base station to start or change interstation-cooperated communication.

27. The interstation-cooperated communication control method according to claim 18, further comprising the step of:
requesting, by the base station, the mobile station and another base station to start or change interstation-cooperated communication.
